(19) United States
(12) Patent Application Publication
(10) Pub. No.: US 2023/0228510 A1
(43) Pub. Date: Jul. 20, 2023

(54) SHOT DETECTION AND VERIFICATION SYSTEM

(71) Applicant: Kordtech PTY LTD, Fyshwick, Australian Capital Territory (AU)

(72) Inventors: Will Boettcher, Fyshwick, Australian Capital Territory (AU); Bruce MacDonald, Fyshwick, Australian Capital Territory (AU); Don Evans, Fyshwick, Australian Capital Territory (AU); Jay Vanmali, Fyshwick, Australian Capital Territory (AU)

(21) Appl. No.: 17/756,809

(22) PCT Filed: Dec. 3, 2020
(86) PCT No.: PCT/AU2020/051325

§ 371 Date: Jun. 2, 2022

(30) Foreign Application Priority Data
Dec. 3, 2019 (AU) 2019904580

(51) Int. Cl. F41A 19/01; G01P 1/02; G01P 1/12; G01P 15/08; G01P 15/18

(52) U.S. Cl. CPC F41A 19/01; G01P 1/023; G01P 1/127; G01P 15/0891; G01P 15/18; G08B 25/10

(57) ABSTRACT

A shot detection system for a projectile weapon comprising: an accelerometer, a power source, a memory; and a processor configured to: receive accelerometer data from the accelerometer; for a first region of interest, test a first property of the accelerometer data; and store a shot determination result in the memory.

### BACKGROUND OF THE INVENTION

There is a need for a projectile weapon-mounted shot detection system. Currently most projectile weapons in use do not have any means of automatically recording when they have been fired. Knowing how many shots have been fired and when is very useful.

Many law enforcement or military organisations replace projectile weapon barrels after a certain period of time regardless of how many rounds have been fired through them. This may result in barrels being replaced after too much wear and tear, which can be dangerous, or too little use which results in wastage and excess costs. A reliable means of counting the number of rounds fired and distinguishing these from non-shot events would eliminate this.

Agencies such as law enforcement or military sometimes have multiple guns discharged in an event with no way of establishing which gun was fired when. Time stamping the recorded shot would allow for time based forensic analysis and graphic representation of the sequence of events.

The reference to any prior art in this specification is not, and should not be taken as, an acknowledgement or any form of suggestion that the prior art forms part of the common general knowledge.

### SUMMARY OF THE INVENTION

According to one aspect of the invention, there is provided a shot detection system for a projectile weapon comprising: an accelerometer, a power source, a memory; and a processor configured to: receive accelerometer data from the accelerometer; for a first region of interest, test a first property of the accelerometer data; and store a shot determination result in the memory.

In some embodiments the processor is configured to test a second property of the first region of interest only if the test of the first property of the first region of interest is passed.

In some embodiments the processor is configured to test a third property of the first region of interest only if the test of the second property of the first region of interest is passed.

In some embodiments the processor is configured to test a fourth property of the first region of interest only if the test of the third property of the first region of interest is passed.

In some embodiments the processor is configured to test a first property of a second region of interest only if all tests of the first region of interest are passed.

In some embodiments the processor is configured to test a second property of the second region of interest only if the test of the first property of the second region of interest is passed.

In some embodiments the processor is configured to test a third property of the second region of interest only if the test of the second property of the second region of interest is passed.

In some embodiments the processor is configured to test a fourth property of the second region of interest only if the test of the third property of the second region of interest is passed.

In some embodiments the processor is configured to test a first property of a fourth region of interest only if all tests of all previous regions of interest are passed.

In some embodiments the processor is configured to test a second property of the fourth region of interest only if the test of the first property of the fourth region of interest is passed.

In some embodiments the processor is configured to test a third property of the fourth region of interest only if the test of the second property of the fourth region of interest is passed.

In some embodiments the processor is configured to test a fourth property of the fourth region of interest only if the test of the third property of the fourth region of interest is passed.

In another aspect of the invention, there is provided a computer implemented method of shot detection comprising: receiving accelerometer data from an accelerometer; for a given region of interest, processing the data to test a first property of the accelerometer data; determining whether a shot has occurred from at least one test result; and optionally storing the shot determination in a memory.

In another aspect of the invention, there is provided a computer implemented method of shot detection comprising: receiving accelerometer data from an accelerometer; for a given region of interest, processing the data to test n properties of the accelerometer data; determining whether a shot has occurred from at least one test result; and optionally storing the shot determination in a memory wherein n is an integer between 1 and 30.

In some embodiments, the method comprises testing a second property of the first region of interest only if the test of the first property of the first region of interest is passed. The method may also comprise testing a third property of the first region of interest only if the test of the second property of the first region of interest is passed. The method may also comprise testing a first property of the second region of interest only if all tests of the first region of interest are passed. The method may also comprise testing a second property of the second region of interest only if the test of the first property of the second region of interest is passed. The method may also comprise testing a third property of the first region of interest only if the test of the second property of the first region of interest is passed.

In some embodiments the method comprises testing a second property of the first region of interest only if the test of the first property of the first region of interest is passed.

In some embodiments the method comprises testing a third property of the first region of interest only if the test of the second property of the first region of interest is passed.

In some embodiments the method comprises testing a fourth property of the first region of interest only if the test of the third property of the first region of interest is passed.

In some embodiments the method comprises testing a first property of a second region of interest only if all tests of the first region of interest are passed.

In some embodiments the method comprises testing a second property of the second region of interest only if the test of the first property of the second region of interest is passed.

In some embodiments the method comprises testing a third property of the second region of interest only if the test of the second property of the second region of interest is passed.

In some embodiments the method comprises testing a fourth property of the second region of interest only if the test of the third property of the second region of interest is passed.

In some embodiments the method comprises testing a first property of a fourth region of interest only if all tests of all previous regions of interest are passed.

In some embodiments the method comprises testing a second property of the fourth region of interest only if the test of the first property of the fourth region of interest is passed.

In some embodiments the method comprises testing a third property of the fourth region of interest only if the test of the second property of the fourth region of interest is passed.

In some embodiments the method comprises testing a fourth property of the fourth region of interest only if the test of the third property of the fourth region of interest is passed.

In various embodiments of this aspect of the invention, the integer may be between 1 and 20 or 1 and 10 or 2 and 8. In some particularly preferred embodiments the integer is between 4 and 8. This range provides a good number of tests to verify that a shot has occurred without taking too much computational power.

In another aspect of the invention, there is provided a computer implemented method for detecting a shot from a projectile weapon comprising: receiving acceleration data generated by an accelerometer in fixed engagement with respect to the projectile weapon; for a first region of interest, testing a first property of the acceleration data; if the test is passed, testing a second property of the acceleration data; determining that a non-shot event has occurred on failure of any one of the first region of interest tests; determining that a shot event has occurred if every one of the first region of interest tests is passed.

In another aspect of the invention, there is provided a method of calibrating test parameters in a shot detection system for a projectile weapon comprising: receiving accelerometer data relating to a plurality of shot events of the projectile weapon; determining at least one region of interest (ROI) from the accelerometer data; receiving instructions in relation to at least one test to be performed on the accelerometer data for each ROI; determining characteristics for at least one acceptance gate in relation to each test; storing said acceptance gate characteristics on a memory.

Another aspect of the invention provides an apparatus for detecting a shot from a projectile weapon comprising a source of power, a processor, an accelerometer, a memory and a means of accessing data stored in the memory.

Another aspect of the invention provides an apparatus for detecting a shot from a projectile weapon comprising a power supply, a microcontroller, an accelerometer, a non-volatile memory chip and a means of accessing the data recorded on the memory chip.

In some embodiments of the invention, the system or apparatus comprises one or more of a real-time clock, a tamper evidence switch, an LED, wireless communication capability and a magneto-resistive switch. Some embodiments of the invention may comprise a real time clock, or a compass or a magnetometer.

Throughout this specification (including any claims which follow), unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

### BRIEF DESCRIPTION OF THE DRAWINGS

FIG. 1 depicts a circuit layout for one example implementation of an apparatus according to the invention.

FIG. 2 depicts a housing for one example implementation of an apparatus according to the invention in respect of Glock recoil-operated semi-automatic pistols.

FIG. 3 shows how a ShotDot is inserted into the grip pocket cavity of a Glock and a ShotDot after it's been inserted into this cavity.

FIG. 4 is a set of graphs of the Z axis accelerometer activity collected from three standard shots fired from a Glock 17 Gen 5 using the system depicted in FIG. 1 and FIG. 2. Vertical dashed lines are overlaid to delineate the initial Regions of Interest (ROIs).

FIG. 5 is a set of graphs of the Z axis accelerometer activity collected from three last shots fired from a Glock 17 Gen 5 using the system depicted in FIG. 1 and FIG. 2. Vertical dashed lines are overlaid to delineate the initial ROIs.

FIGS. 6a to 6d are sets of graphs of the X and Y axis data from the three standard shots and three last shots for which Z axis data is depicted in FIGS. 2 and 3 respectively. Vertical dashed lines are overlaid to delineate the final ROIs.

FIG. 7 depicts Z, X and Y axis data from the standard shot 1 referred to in FIGS. 4, 4a and 4c respectively after this data has undergone calibration and rectification.

FIG. 8 depicts an example process flow for shot detection according to one aspect of the invention.

FIG. 9 is a set of graphs of the Z axis accelerometer activity collected from three standard shots fired from a Glock 19 Gen 5 using the system depicted in FIG. 1 and FIG. 2. Vertical dashed lines are overlaid to delineate the ROIs.

FIG. 10 is a set of graphs of the Z axis accelerometer activity collected from three last shots fired from a Glock 19 Gen 5 using the system depicted in FIG. 1 and FIG. 2. Vertical dashed lines are overlaid to delineate the ROIs.

FIG. 11 is a set of graphs of the Z axis accelerometer activity collected from three standard shots fired from a Glock 45 using the system depicted in FIG. 1 and FIG. 2.

FIG. 12 is a set of graphs of the Z axis accelerometer activity collected from three last shots fired from a Glock 45 using the system depicted in FIG. 1 and FIG. 2.

### DETAILED DESCRIPTION OF EXEMPLARY EMBODIMENTS

The present invention provides a shot detection device system which is small, has a long battery life and can be mounted securely and unobtrusively. In some embodiments it has wireless communication such as Bluetooth Low Energy (BLE). Additional features may include anti-tamper and/or tamper detection technology. In preferred embodiments it is microcontroller controlled, it has a means of detecting and recording shot events so that they can be reviewed. It also has a means of discriminating between actual shot events and non-shot impact events (such as a dropped weapon) such that a shot is not falsely recorded. Circuitry may include a real time clock to timestamp shots, memory to record the data and a means of communicating with an external device, such as Bluetooth Low Energy or USB.

Having wireless communications allows for additional capabilities, such as on the go communication of data or device configuration. By maintaining or initiating a connection to a network enabled mobile device such as a phone, a shot-fired alert can be communicated for example to a police dispatcher. A wireless shot detector may also periodically attempt to connect to a server to exchange information, for example an armoury may have a wireless server that transfers information and synchronises the clocks of stored guns during a low-use period, such as late at night.

In some implementations, there is provided an application (or app) that communicates with the shot detection system. The app may have different levels of security to ensure sovereignty of data. For example, an armourer may have a higher level of access and can configure or reset the shot counting device however a user may only be able to access the data.

Methods for detection of removal or insertion of the device from a weapon may permit time-stamping of those events for further security. These may be implemented by mechanical or electrical methods.

The shot detection system may also function in other modes, for example sporting shooters may use it to determine split times, draw times and other statistics. Personal gun owners may put the unit into a security mode wherein any movement or handling detected by the accelerometer would trigger an alert. Thus for example, a personal gun owner may be alerted on a mobile App that their gun has just been moved or handled.

Within this specification and any claims that follow, the following terms have the following meanings unless otherwise indicated:
Fixed hardware platform: a specific projectile weapon (including make and model), projectile type and 3-axis accelerometer mounting method, for which an accelerometer is rigidly mounted to the projectile weapon in a fixed location and orientation.
Last shot—the point at which the final shot in a magazine is fired from a self-loading projectile weapon, resulting in the absence of any acceleration activity associated with such a weapon loading the next magazine round into the chamber.
Projectile type: a projectile with characteristics such as mass and initial speed fixed and defined.
Projectile weapon: a weapon which can be discharged in order to propel a projectile.
Recoil signature: properties of the three components of the combined acceleration vector acting on a projectile weapon when firing a shot.
Region of Interest (ROI): a specific region of time during or after which a projectile weapon has been discharged.
Shot: the discharge of a projectile weapon.

To propel a projectile, a projectile weapon must exert a force (directly or indirectly) on the projectile. As stated by Newton's third law of motion, for every action, there is an equal and opposite reaction. Hence the projectile must exert an equal and opposite force on the projectile weapon, causing recoil. Although many modern projectile weapons implement mechanisms to reduce or dampen recoil, with the exception of truly recoilless projectile weapons, all projectile weapons experience a non-zero recoil force. Due to Newton's second law of motion, force and acceleration are directly proportional according to the equation

Force=mass×acceleration

and hence all projectile weapons intended for compatibility with the present invention also experience a non-zero recoil acceleration.

Taking the situation of a given projectile being fired from a given projectile weapon, at any given moment in time after the projectile is propelled there exists a limited range of possible acceleration vectors which can act upon the projectile weapon. Each of these possible acceleration vectors can be broken down into the components acting on three orthogonal axes with respect to the projectile's initial direction. The combination of these three components of the combined acceleration vector is defined as the recoil signature and can be measured by a 3-axis accelerometer on axes X, Y and Z. The recoil signature range of a projectile weapon is defined as the possible range of the three components of the combined acceleration vector at each instant in time from when a shot is fired up until the time after which said projectile weapon could realistically fire a shot again.

Which axes are defined as X, Y and Z is arbitrary, as long as these axes are clearly defined and the accelerometer is rigidly mounted relative to the body of a given projectile weapon in a fixed location and orientation. For the purposes of this example, when considering an operator standing upright and firing a projectile weapon such that the projectile is propelled in a direction generally parallel to the Earth's surface, the line created by extrapolating the initial direction of the projectile is defined as the Z axis, the up/down line perpendicular to the Earth's surface the X axis and the left/right line both perpendicular to the initial direction of the projectile and parallel to the Earth's surface the Y axis. Note that the value of acceleration on each of these axes can be positive or negative. Acceleration in the initial direction of the projectile is henceforth defined as −Z acceleration, the opposite direction as +Z, down as −X, up as +X, right as −Y and left as +Y. All X, Y and Z acceleration components discussed herein are defined with respect to the acceleration experienced by the projectile weapon.

The degree to which each is acted upon by acceleration caused by gravity will change depending on the tilt and angle of elevation of the projectile weapon. Hence the recoil signature of the projectile weapon will vary with tilt and angle of elevation; however, this variation is negligible with respect to the vastly higher magnitude accelerations experienced when a shot is fired from a modern projectile weapon and hence angle of elevation can be ignored for present purposes. This is particularly so for law enforcement, military or sporting shooter projectile weapons.

It has surprisingly been found that in many instances, the forces acting on the X axis (up and down) are equal to or greater than those on the Z axis (along the line that the projectile is fired). It further appears that this is particularly so for less experienced users of the weapons. Without wishing to be limited by theory, it appears that a less experienced user may not hold the weapon as rigidly in relation to up and down movement as a more experienced operator will. This effect is in direct contrast to prior art systems which rely on detecting a force along the Z axis and can therefore be in error. In some instances, such prior art systems are unable to differentiate a shot from the barrel of the gun being tapped on a table.

The present invention discloses a method and apparatus for a shot detection system particularly suited for use with modern law enforcement, military or sporting shooter projectile weapons.

In terms of circuitry, the shot detection system requires a source of power, a processor, an accelerometer, a memory and a means of accessing data stored in the memory. In some embodiments, the shot detection system comprises a power supply, a microcontroller, an accelerometer, a non-volatile memory chip and a means of accessing the data recorded on the memory chip. Optional components which may improve the shot detection system for various embodiments are a real-time clock, a tamper evidence switch, a LED, wireless communication capability and a magneto-resistive switch.

A housing for the circuitry is preferable but not necessary as long as the accelerometer can be securely mounted to or within the projectile weapon in a repeatable fashion such that there is a rigid physical coupling between the shot detection circuitry and the projectile weapon. If present, the housing can take any form as long as the accelerometer contained within is securely mounted to or within the projectile weapon in a repeatable fashion such that there is a rigid physical coupling between the shot detection device and the projectile weapon. Any mounting mechanism for which the accelerometer moves in unison with the body of the projectile weapon is suitable.

While the ShotDot embodiment is specifically designed to be compatible with Glock pistols, other mounting mechanisms can be employed for other weapon platforms to achieve the rigid physical coupling required between the shot detection device and the projectile weapon.

One example of how this can be done is via design of a shot detection device housing with an integrated Picatinny rail grabber. Picatinny rails are a military standard rail interface system which are present on many of the military rifles currently in service. Many in-service rifle mounted accessories such as the Mini Integrated Pointing Illumination Module (AN/PEQ-16B) already use integrated Picatinny rail grabbers to achieve a rigid mount between the accessory and the rifle it is being attached to. Picatinny rails are less common on pistols but accessories such as the Mako Universal Picatinny Rail Mount can be retro fitted to pistols to allow a shot detection device housing featuring an integrated Picatinny rail grabber to be mounted.

Another example of how the rigid physical coupling can be achieved in assault rifles is to use the cavity which is present in the hollow pistol grips of most modern assault rifles, such as the M16. These hollow pistol grips have a hole at the top, through which a bolt is inserted to screw them tightly to the lower receiver of the assault rifle. Designing a shot detection device housing with a cylindrical void through its centre would enable the housing to be bolted to the top of this pistol grip cavity using the same bolt which secured the pistol grip to the lower receiver.

Circuitry

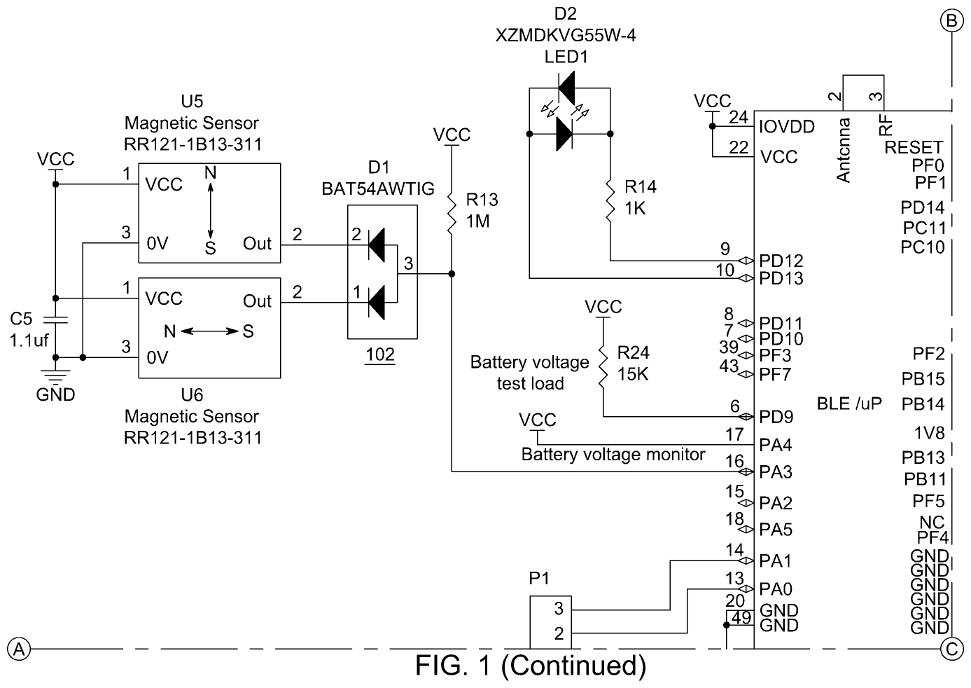

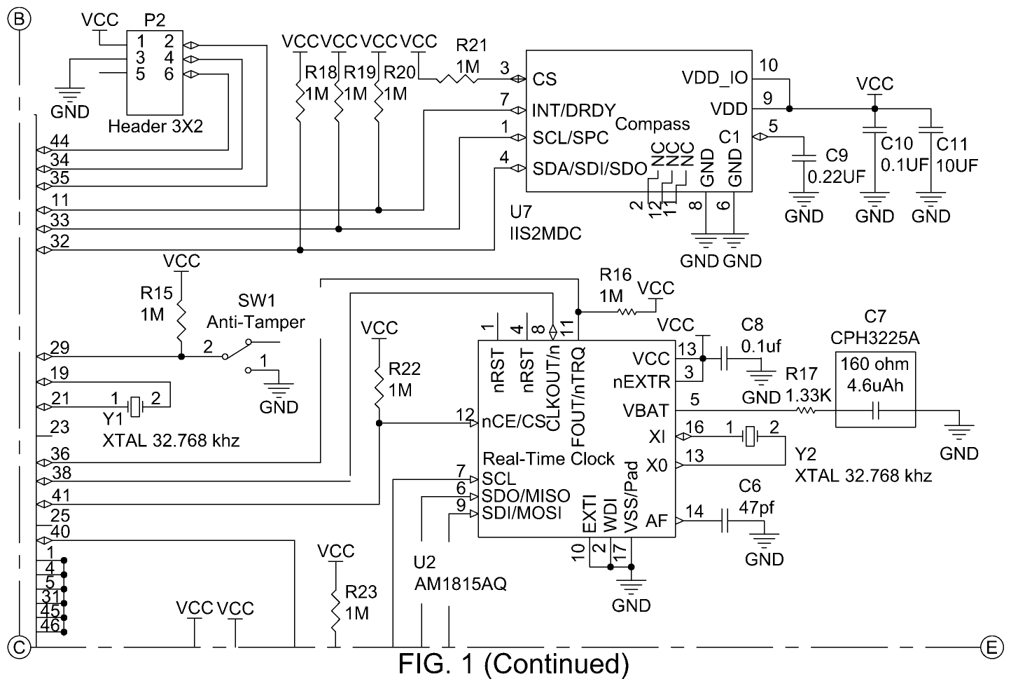

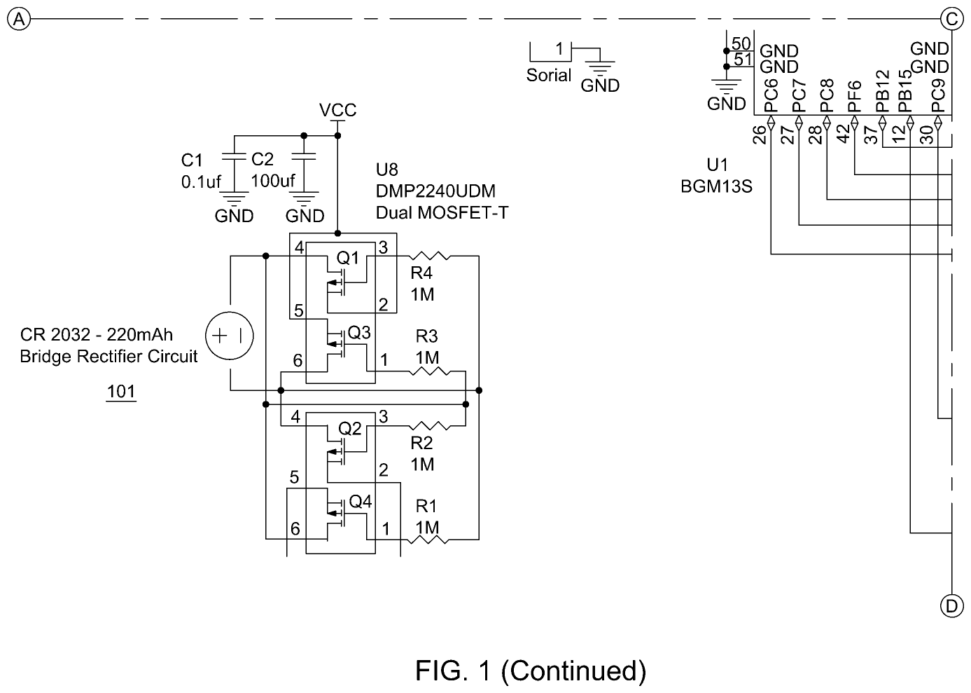

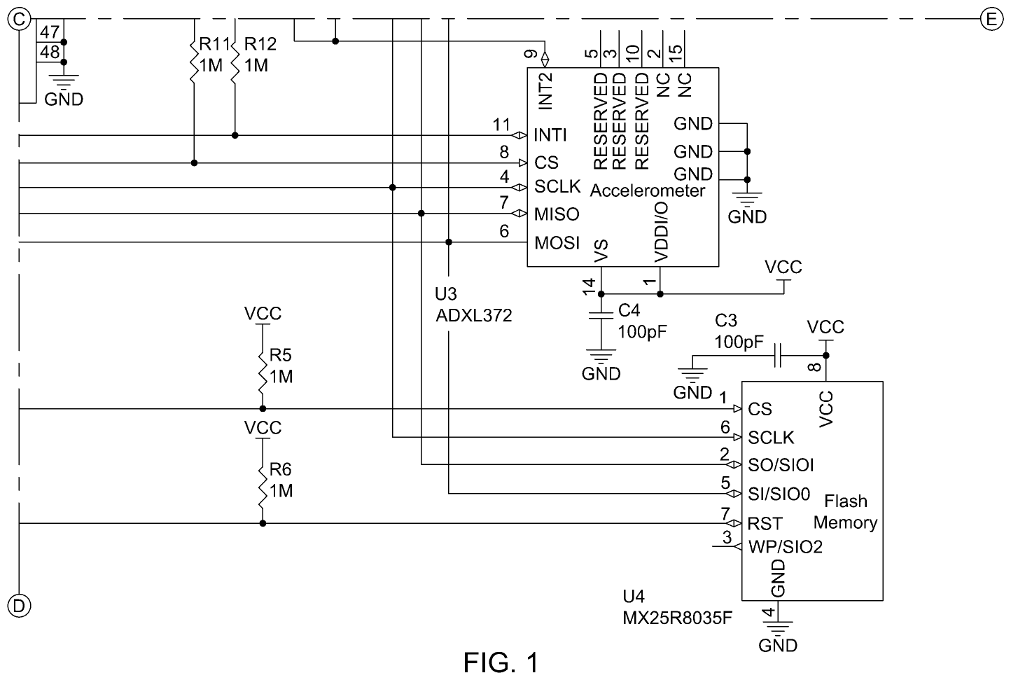

FIG. 1 depicts a circuit layout for one example implementation of an apparatus according to the invention. The circuitry depicted has been proven to work as an apparatus for an effective shot detection system when mounted rigidly and repeatably to a Glock 17 Gen 5, Glock 19 Gen 5 or Glock 45 recoil-operated semi-automatic pistol. Although the 3-axis accelerometer mounting method may need to be changed for this circuitry to function as an apparatus for an effective shot detection system with other models of Glock pistols or on non-Glock projectile weapons, the electronic components described below are generic and can be used as an apparatus for an effective shot detection system on any projectile weapon which experiences recoil.

In this example, the circuit design is based on three primary building blocks. These primary blocks comprise the power supply, 32-bit ARM® Cortex®-M4 core at 38.4 MHz central microcontroller and peripheral devices that deliver functionality. The peripheral devices managed by the microcontroller are the accelerometer, flash memory, real time clock and compass integrated circuits together with the Bluetooth 5 wireless connectivity which is integrated in the microcontroller.

The power supply block is shown at 101. The main shot detection system circuit runs from raw voltage supplied from a single 3-volt CR2032 Lithium coin cell battery. Supporting components shown in U8 comprise a 0.1 uf ceramic capacitor and a 100 uf low leakage ceramic capacitor which provide noise filtering and reservoir capacity to the battery during short repetitive current demands, as well as a dual-MOSFET bridge rectifier which enables the main circuit to run from the battery regardless of insertion polarity.

102 contains all components of the main circuit. A description of each key component is provided below.

U1, Silicone Labs BGM13S22F512GA-V2 is a Bluetooth Low Energy v5.0 Transceiver Module 2.4 GHz with Integrated 32-bit ARM® Cortex®-M4 core at 38.4 MHz. This is the central microcontroller of the shot detection system and supports all peripheral devices via an integrated SPI bus, I2C bus and general purpose digital and analog I/O ports. It also hosts all shot detection system embedded firmware.

U1 is a highly integrated device containing Bluetooth Low Energy, microprocessor, integrated antenna, general purpose and DAC I/O, low power sleep modes, integrated operational amplifiers, UART/SPI and I2C interfaces. This device complies with Part 15 of the FCC Rules and Certification. The BGM13S22F512GA-V2 operates on a wide 1.8 V to 3.3 V supply range.

The BGM13S22F512GA also provides Bluetooth Low Energy 5.0 connectivity. It supports 2 Mbps, 1 Mbps and coded LE Bluetooth PHYs. With 512 kB of flash and 64 kB of RAM, the BGM13S22F512GA-V2 is suited to meet Bluetooth Mesh networking memory requirements effectively. This Bluetooth Low Energy functionality is used as the transport mechanism to download ShotDot data to an external device for post event processing.

U2, Ambiq Micro AM1815AQ is a real-time clock (RTC) module with power management and ultra-low power (as low as 14 nA), coupled with a highly sophisticated feature set. The AM1815AQ includes on-chip oscillators to provide minimum power consumption, full RTC functions including battery backup and programmable counters and alarms for timer and watchdog functions, and either an I2C or SPI serial interface for communication with a host controller. U2 is used to date time stamp data to 0.1 of a second. U2 is currently controlled by U1 via the SPI bus and 1 interrupt line.

U3, Analog Devices ADXL362 is an ultralow power, 3-axis MEMS accelerometer that consumes less than 2 μA at a 100 Hz output data rate and 270 nA when in motion triggered wake-up mode. The ADXL362 has many features to enable true system level power reduction. It includes a deep multimode output FIFO, a built-in micropower temperature sensor and several activity detection modes including adjustable threshold sleep and wake-up operation that can run as low as 270 nA at a 6.4 kHz measurement rate. U3 is currently controlled by U1 via SPI bus and 2 interrupt lines. The ADXL362 operates on a wide 1.6 V to 3.5 V supply range

U4, Macronix MX25R8035F is an 8 Mb serial NOR flash memory module, which is configured as 1,048,576×8 internally. U4 is used to store shot detection system data for post event data download. U4 can be controlled via SPI or I2C bus. U4 is currently controlled by U1 via SPI bus, an interrupt line and a reset line. The MX25R8035F operates on a wide 1.65 V to 3.6 V supply range.

U5 and U6 are a pair of magnetic sensors used to enable a form of user input into U1. The magnetic sensor circuit will switch from VCC to ground when in close proximity to a suitably powered magnet. The output of the magnetic sensor circuit is monitored by an interrupt line on U1, hence the microcontroller is notified via interrupt when the user holds a magnet close to the circuitry. The magnetic sensor circuit interrupt is currently configured to put U1 into Bluetooth Low Energy pairing mode so the user can wirelessly connect to a USB dongle for shot log data download, or to a radio to set up the shot fired alert capability.

The magnetic sensors have a north/south polarity. Two magnetic sensors mounted perpendicularly with respect to each other are used rather than one to reduce sensitivity to the direction that the activating magnet approaches from.

U7 (IIS2MDC) is a highly accurate ultra-low power digital magnetometer which is currently used as a compass. The compass functionality is desirable on the shot detection system because it allows the system to log the direction the projectile weapon was pointed in when a logged shot was fired. U7 can be controlled via SPI or I2C bus. U7 is currently controlled by U1 via the I2C bus. The IIS2MDC operates on a wide 1.71 V to 3.6 V supply range

D2 is a LED used as a means of providing the user feedback. It currently provides feedback on boot events, when the shot detection system is put into pairing mode (via magnetic sensor activation) and when it is successfully paired.

P2 is a six-pin programming header used to load new firmware onto the shot detection system.

SW1 is a tamper evidence switch whose output is routed into an interrupt pin on U1. SW1 is designed to close when the shot detection system is installed into a cavity on the weapon it is logging shots on. If the shot detection system is removed from the weapon, the switch will open, U1 will be notified via interrupt and U1 will record in flash memory a timestamped event that the system was removed from the weapon it was installed in.

Housing

FIG. 2 depicts a housing for one preferred embodiment of an apparatus according to the invention in respect of certain Glock recoil-operated semi-automatic pistols. This embodiment of the shot detection system is called the ShotDot.

The body of the ShotDot housing is shown at 201. This body is manufactured by low pressure moulding over the ShotDot PCB and is designed to be inserted into the grip pocket cavities of the Glock 17 Gen 5 and Glock 19 Gen 5 pistols.

The outer shape of this housing body between 201 and 202 was entirely informed by the shape of the cavities inside the grip pockets of the Glock 17 Gen 5 and Glock 19 Gen 5 pistols. This section of the body is designed to be inserted into the grip pocket cavity of these Glock models before the ShotDot is used to detect shots from them. Moulds were taken of the internal grip pocket cavities of these two firearms. They were almost the same but not identical. Common parts of the two moulds were combined in a CAD program to create the tapered shape shown between 201 and 202. Other angles of this tapered shape are shown at 203 and 204. The raised edge and cutout shown at 202 engage with features inside the Glock 17 Gen 5 and Glock 19 Gen 5 grip pocket cavities to a secure fit when the ShotDot is inserted into these pistols' grip pocket cavities.

This same ShotDot housing body also fits securely into the grip pocket cavities of all the Glock models listed in the table below.

| MODEL | | CALIBRE |
|---|---|---|
| G17 | G17 Gen 3 | 9 mm |
| | G17 (CA) | 9 mm |
| | G17L Gen 3 | 9 mm |
| | G17L Gen 4 | 9 mm |
| | G17L Gen 5 | 9 mm |
| | G17 CUT Gen 4 | 9 mm |
| | G17T Gen 4 | 9 mm |
| | G17R Gen 4 | 9 mm |
| | G17 Gen 5 | 9 mm |
| | G17 Gen 5 MOS | 9 mm |
| G19 | G19 | 9 mm |
| | G19 X | 9 mm |
| | G19 (CA) | |
| | G19T Gen 4 | 9 mm |
| | G19 Gen 5 | 9 mm |
| | G19 Gen 5 MOS | 9 mm |
| | G34 Gen 5 MOS | 9 mm |
| G34 | G34 Gen 4 | 9 mm |
| | G34 (CA) | 9 mm |
| | G34 Gen 5 MOS | 9 mm |
| G45 | G45 | 9 mm |
| | G45 MOS | 9 mm |
| G47 | G47 | 9 mm |
| G22 | G22 Gen 3 | 0.40 |
| | | S&W |
| G22 | G22 Gen 4 | 0.40 |
| | | S&W |
| G23 | G23 Gen 3 | 0.40 |
| | | S&W |
| | G23 Gen 4 | 0.40 |
| | | S&W |
| G44 | G44 | 0.22 |

The indent or cutout at 205 was designed to enable the Beavertail backstrap accessory to be fitted to a Glock with a ShotDot already inserted. When fitted, the Beavertail backstrap wraps around the base of a Glock's grip and without the cutout 205 having a ShotDot fitted would prevent a backstrap being fitted.

The feature at 206 was designed both to allow extra room for circuitry in the body of the ShotDot housing and to provide the user a solid, robust section of the housing they could grip while inserting and removing the ShotDot from the grip pocket cavity of a compatible Glock. 207 is a soft transparent insert which is pushed into a cavity in the body of the housing to cover the LED and keep it watertight while also keeping the LED visible to the user. 207 achieves an IP67 waterproof rating when inserted into the grip pocket cavity of a compatible Glock. It relies on the pressure exerted on 207 by the surrounding wall of the Glock's grip pocket cavity to achieve this waterproof seal.

208 is a screw plate insert nut which fits snugly via friction fit into a cavity in 201 to provide an anchoring point for a grub screw. When 201 has been inserted into the grip pocket cavity of a compatible Glock, the thread presented by 208 aligns with the hole at the base of the rear of the Glock grip. Winding a grub screw through this hole and into 208 ensures a rigid physical coupling between the shot detection circuitry and the projectile weapon. A grub screw with a special tooled head can also be inserted here to provide extra tamper evidence security for the ShotDot.

209 is the CR2032 coin cell battery used to power the ShotDot. It is inserted into the PCB-mounted battery holder which is located in the cutout directly above it in FIG. 2.

210 is a soft silicone part designed to hold the CR2032 battery under pressure when the ShotDot is inserted into a compatible Glock. Its size and shape were determined primarily by the size of the CR2032 battery it is designed to cover. Grooves around the top edges of 210 mate with features on the housing body 201 to provide an IP67 waterproof rating when inserted into the grip pocket cavity of a compatible Glock. 210 relies on the pressure exerted on it by the surrounding wall of the Glock's grip pocket cavity to achieve this waterproof seal.

The nipple 211 is a feature of 210 which sits directly over the tamper evidence switch. Its purpose is to protect the tamper evidence switch. The taper on the nipple will enable gradual engagement of the tamper evidence switch and prevent the switch from experiencing shearing forces when the ShotDot is inserted forcefully into a compatible Glock.

212 is a side view of the ShotDot. 213 is a rear view of the ShotDot. 214 is a bottom view of the ShotDot—this is the section of the housing body that protrudes from a Glock after a ShotDot has been inserted.

301 in FIG. 3 shows how a ShotDot is inserted into the grip pocket cavity of a Glock. 302 shows a ShotDot after it's been inserted into this cavity. Note the hole at the back of the grip in 302—this is the hole that the grub screw goes through to screw into 208 and secure the rigid coupling between the Glock and the ShotDot.

The benefits of fitting the ShotDot into the grip pocket cavity include: ensuring a rigid coupling between the ShotDot and the Glock; making use of unused space inside the Glock rather than making the firearm bulkier by externally attaching to its housing; housing and circuitry of the ShotDot are gain additional protection by being mostly encased by the Glock housing, and; ability to have a tamper evidence switch which can log when the ShotDot was installed and removed from a Glock.

This exemplary housing illustrates one method by which a tight engagement between the device of the invention and the weapon can be achieved. As explained above, this is important to enable movement of the device with recoil of the weapon and therefore accurate shot detection.

### Example Method

To function on a fixed weapon platform, the shot detection system requires a database of verified shot events from the same fixed hardware platform. Its effectiveness and accuracy as a shot detection system will increase as the size of the database of recorded shots increases. Once data collection commences on a fixed hardware platform, compilation of a database of the recoil signature range for that fixed hardware platform can begin.

The shot detection system is designed to analyse accelerometer data every time a significant acceleration event occurs. The threshold for what constitutes a significant acceleration event is application dependent. As an example, for modern law enforcement, military or sporting shooter projectile weapons, the threshold would be set to 40 g of acceleration or more (that is forty times the acceleration associated with gravity, ie 392.4 m/s² or more).

Numerous actions can generate a significant acceleration event such as a dropped weapon, an actual shot or even forceful reloading, cocking or racking the weapon. Hence the shot detection system cannot simply record a shot every time a significant acceleration event occurs. A method of differentiating between actual shots and other high acceleration non-shot events is required.

To do this the shot detection system of the invention implements a shot confirmation algorithm which compares real-time acceleration based properties of the significant acceleration event being processed with historical acceleration based properties derived from the database of verified shots. All analysed properties of the acceleration event being processed must fall within or around the bounds of what has been determined from historical data to be the characteristics of a confirmed shot.

Region of Interest Methodology

Due to variations in the exact position of acceleration spikes in recoil signatures, the analysis of single data points from the accelerometer is inconclusive. Similarly, analysing sub-millisecond snapshots of acceleration on any axis is of limited use. The shot detection system of the invention instead uses properties contained within regions of interest (ROIs), wherein each ROI consists of multiple accelerometer data points collected over a time period, in this example, of at least one millisecond.

Acceptance Gates

The shot confirmation algorithm works by creating a series of acceptance gates based on known ROI properties of the recoil signature of a fixed weapon platform. Each ROI will have at least one acceptance gate associated with it, and each acceptance gate will have at least one upper and one lower bound. All bounds are empirically derived from ROI property values collected from a database of verified shots for the fixed weapon platform for which the algorithm is designed. In some preferred embodiments, each significant acceleration event processed must have ROI properties that pass between a lower and upper bound of every acceptance gate test making up the shot confirmation algorithm before a shot is confirmed to have taken place. In some embodiments, for example where it is less important to identify a true shot for each event, less stringent requirements may be set.

For example, for a Glock 17 Gen 5 pistol, ROI 1 is from 0 to 6.59 ms after a significant acceleration event occurs and accelerometer data processing begins. From a historical database of 1000 verified shots, it is known that every shot on this fixed weapon platform had a peak acceleration value between 150 and 220 g of acceleration within ROI 1. An acceptance gate is created based on this data with a lower and upper bound of, for example, 135 and 242 g respectively. When a significant acceleration event occurs, the microcontroller reads in acceleration values from the accelerometer. According to the preferred embodiments, for the event to pass this acceptance gate, a peak acceleration value greater than the lower bound of 135 g but less than the upper bound of 242 g would have to appear at some point in the time period of ROI 1. If the peak acceleration value for the time period 0-6.59 ms was recorded to be less than 135 g, or higher than 242 g, then the event would be rejected as a non-shot event and therefore not recorded as one.

The acceptance gate minimum bound for any given property must be equal to or less than the lowest recorded value of the corresponding property in verified shot data. Similarly, the acceptance gate maximum bound for any given property must be equal to or more than the highest recorded value of the corresponding property in verified shot data. For the preferred embodiments, when verified shots from the database are back-tested through acceptance gates embedded in the shot confirmation algorithm, every verified shot must pass every acceptance gate, as otherwise the shot confirmation algorithm is invalid.

Determining ROIs

Given a database of shots for a fixed hardware platform, the method of determining ROIs consists of comparing database entries to identify ROIs containing information which is repeatable in verified shots. Any facet of accelerometer activity in a fixed hardware platform's recoil signature which is present in all recorded shots is deemed to be useful information.

An ROI is defined as any period of time between ta (time a) and tb (time b) which contains useful information about the recoil signature. Useful information may be the presence or absence of activity when examining a particular axis. ta can be assigned any value greater than or equal to t0, where t0 is defined as the instant the projectile begins accelerating from its resting point in the projectile weapon. tb can be assigned any value greater than ta but less than tfinal, where tfinal is the elapsed time after which the projectile weapon being considered could realistically be fired again.

According to this example, properties of the recoil signatures which are compared to identify ROIs with repeatable activity between shots in the database are total activity on the X axis, Y axis, Z axis and the sum of total activity over all axes. Depending on the characteristics of the recoil signature, anywhere between one and four of these properties may be used in the shot confirmation algorithm. There is no limit to the number of ROIs that can be associated with each recoil signature property.

Determining ROI Total Activity Acceptance Gate Bounds for Shot Confirmation Algorithm

Once ROIs have been determined for each useful recoil signature property, the verified shot database is parsed to find the all-time minimum recorded value associated with that recoil property in that ROI, and the all-time maximum recorded value. With any database of multiple verified shots on a fixed hardware platform, there will always be variation between the all-time minimum and maximum recorded values for a given recoil property of a given ROI.

Although there are ROIs for specific properties of shots which do not vary greatly between shot events, variance in recoil signatures will occur even with a fixed hardware platform due to factors such as wear and tear of moving parts of the projectile weapon. A more significant factor causing variance in recoil signatures is when the last shot in a magazine is fired from a self-loading projectile weapon. Such weapons use recoil energy (directly or indirectly) to load the next projectile after a shot has been fired. When the last shot from a magazine has been fired, the recoil energy usually spent loading the next projectile can instead be stored as potential energy in a recoil spring or similar mechanism. The act of this recoil energy being stored as potential energy rather than kinetic energy can significantly alter the recoil signature of a last shot. Accordingly, an ROI which contains information regarding the dissipation of recoil energy may need to be altered to cater for the special case of last shots. This can be done for example via either modification of the ROI values to and tb or modification of the associated ROI acceptance gate bounds.

In the case of hand-held projectile weapons, the shooting style of an individual operator also has a significant impact on the recoil signature of a fixed hardware platform.

The grip strength and shooting stance of an operator directly impacts the recoil experienced by the projectile weapon, as by bracing their body against the weapon one particular operator can absorb more or less of the recoil than another. Hence buffer regions or buffers are required between the previously recorded maximum value for a given property and ROI and the associated shot confirmation algorithm upper bound, and between the previously recorded minimum and the associated shot confirmation algorithm lower bound.

Once the all-time maximum and minimum recorded values have been recorded, the shot confirmation algorithm upper and lower acceptance gate bounds can be determined and added to the algorithm for the shot detection device. For a given intended level of accuracy, the size of the buffer required between the previously recorded values and the associated algorithm acceptance gate bounds also depends on how many verified shot events have been recorded for the fixed hardware platform the shot detection device is being programmed for.

With a relatively small database of verified shots on a fixed hardware platform, large buffers are required to extend the algorithm acceptance gate bounds in anticipation of a future event, for example caused by a projectile weapon (of the same make and model) or operator which produces a significantly different recoil signature. As the database of verified shots grows larger, the level of certainty increases that a shot will not occur which strays too far outside the bounds of previously recorded data, and hence the size of the buffers extending the algorithm acceptance gate bounds can be decreased accordingly. A table listing an example implementation of how these algorithm buffers could be decreased as the number of verified shots in the recorded database grows is shown below.

| Verified shots | ROI lower | |
|---|---|---|
| in database | algorithm bound | ROI upper algorithm bound |
| 3 | Minimum all time | Maximum all time value +50% |
| | value −50% | |
| 10 | Minimum all time | Maximum all time value +40% |
| | value −40% | |
| 100 | Minimum all time | Maximum all time value +30% |
| | value −30% | |
| 1000 | Minimum all time | Maximum all time value +20% |
| | value −20% | |
| 10000 | Minimum all time | Maximum all time value +10% |
| | value −10% | |

Common statistical measures such as standard deviation can also be utilised to inform appropriate values for acceptance gate bounds. For example, it may be determined that the gate bounds are 2 or 3 standard deviations out.

Determining ROI Total Activity Ratio Acceptance Gate Bounds for Shot Confirmation Algorithm

Comparing the ratio of total activity between certain axes informs additional tests which can be inserted into the shot confirmation algorithm. It has been found that total activity on both the Z and X axes over any duration ta to tb is typically larger than the total activity on the Y axis. This aspect of recoil signature is expected since, when propelling a projectile in the forwards direction (Z axis), a projectile weapon typically recoils backwards (Z axis) and upwards (X axis) more so than left or right (Y axis).

The total activity ratio tests' shot confirmation algorithm acceptance gate bounds are determined for each ROI in much the same way as the total activity acceptance gate bounds. The database is parsed for the all-time minimum and maximum values recorded for:

Ratio of Y:Z;

Ratio of Y:X; and

Ratio of Y:SUM

where X, Y and Z are defined as:

X=total activity on X axis (ta to tb);

Y=total activity on Y axis (ta to tb);

Z=total activity on Z axis (ta to tb); and

SUM=(total activity on X axis (ta to tb)+total activity on Y axis (ta to tb)+total activity on Z axis (ta to tb))

then buffers of an appropriate size are applied in order to determine the bounds of the corresponding shot confirmation algorithm test. A table listing an example implementation of how these algorithm buffers could be decreased as the number of verified shots in the recorded database grows is shown below.

| Verified shots | ROI lower | |
|---|---|---|
| in database | algorithm bound | ROI upper algorithm bound |
| 3 | Minimum all time | Maximum all time value +50% |
| | value −50% | |
| 10 | Minimum all time | Maximum all time value +40% |
| | value −40% | |
| 100 | Minimum all time | Maximum all time value +30% |
| | value −30% | |
| 1000 | Minimum all time | Maximum all time value +20% |
| | value −20% | |
| 10000 | Minimum all time | Maximum all time value +10% |
| | value −10% | |

Zero Drift Correction

Another aspect of the present invention is computational real-time correction of the zero drift on each accelerometer axis. Zero drift is an inherent property of accelerometers, with the effect that the X, Y and Z axis readings when subjected to no acceleration will drift away from true zero over time. Inaccuracy in true zero readings can also be present in accelerometers at the time of manufacture depending on the tolerances of components used in manufacturing.

In some embodiments, computational zero drift correction takes place automatically every time a shot is confirmed by the shot confirmation algorithm. In all projectile weapons examined thus far there was a significant period of zero acceleration (>10 milliseconds) present on all three axes at some point between t0 and tfinal. Such a period of zero acceleration is repeatable in verified shots and hence would have already been identified as an ROI via the steps outlined in the determining ROIs section above. The automatic zero drift calculation is applied immediately after a shot has been confirmed.

For the X axis, the amount of zero drift is determined by calculating the average of all uncalibrated X axis values recorded within a zero activity ROI on completion of each shot confirmed event. This X axis zero drift offset value is stored in non-volatile memory. The next time an acceleration event occurs and is processed by the microcontroller, the current X axis zero drift offset is subtracted from each X axis value read in from the accelerometer to calibrate the new data before it is processed to determine whether it was a shot or non-shot event. Zero drift calibration is carried out in an identical fashion for the Y and Z axes.

Power Reduction

To reduce power consumption, by default the shot detection device stays in a low-power state until the accelerometer notifies the microcontroller that a significant acceleration event has occurred. The magnitude of acceleration that constitutes a significant acceleration event is application specific and appropriate thresholds are determined from data collected in the verified shot database before being programmed into the accelerometer. Acceleration thresholds may be applied to any of the X, Y and Z axes. The magnitude of these thresholds may be the same or different for each axis.

When in a low-power state, all active components on the shot detection device are in sleep mode, including the accelerometer. Before instructing the accelerometer to go into sleep mode, the microcontroller programs the accelerometer to wake on an acceleration event above a certain threshold. When the accelerometer wakes due to the significant acceleration event threshold being exceeded, it notifies the microcontroller to wake up and process the event data.

Notification of a significant acceleration event occurs via the accelerometer changing the state of an interrupt line which is connected to and monitored by the microcontroller. When this notification occurs, the microcontroller wakes up to read in and process data from the accelerometer.

Order of Tests

The shot confirmation algorithm tests are implemented in chronological order with respect to the end points of the ROIs, i.e. shot confirmation tests are executed on the ROI possessing the lowest value of tb first. This ROI is called ROI1. After the first suite of tests are completed, the second set of shot confirmation tests is executed on the ROI with the second lowest value of tb (ROI2) and so on. The final suite of tests to be executed are those regarding ROIs where tb=tfinal. The tests are done in this order so that the shot detection system can go back to sleep as soon as possible when woken by a non-shot event. If a non-shot activity has generated a significant acceleration event and woken the shot detection device, often this can be determined within a few milliseconds.

Determining ROIs for Standard Shots

For illustrative purposes only, relevant principles are illustrated herein by reference to graphical depictions of the data.

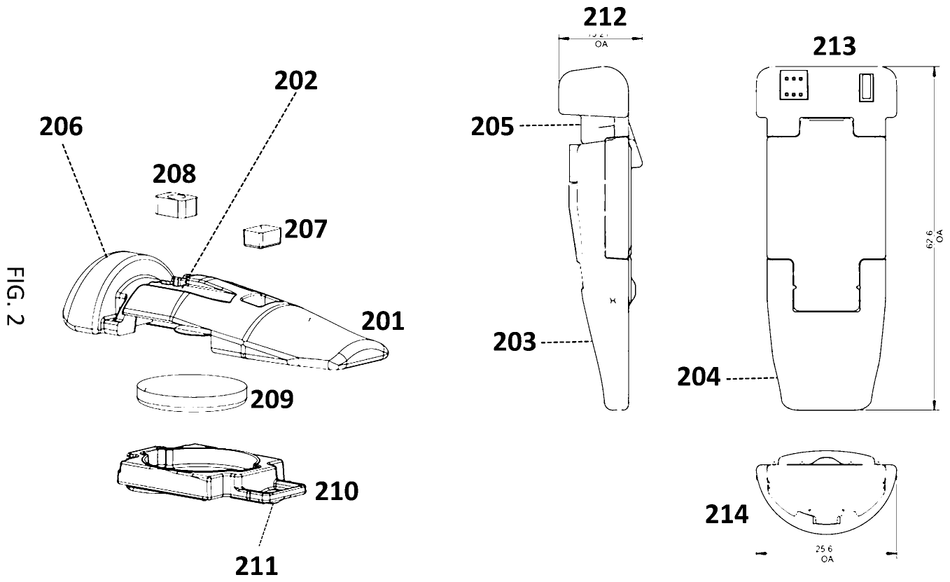

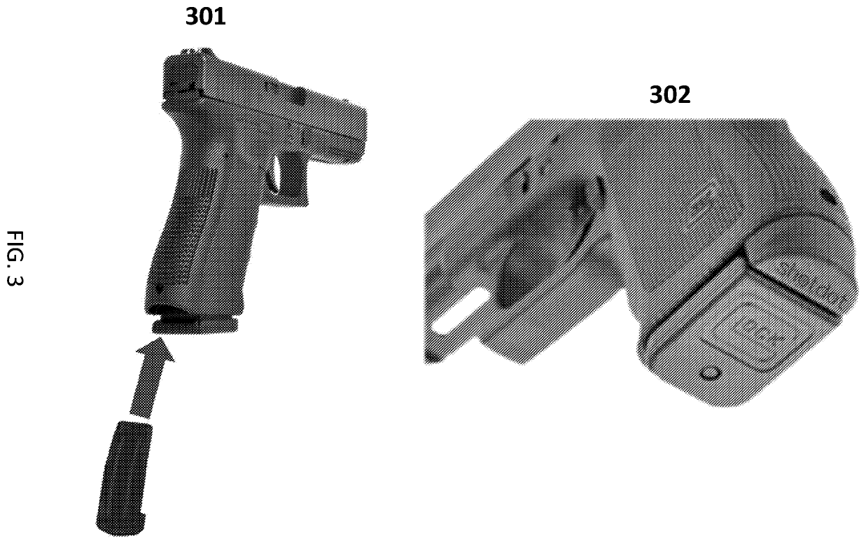

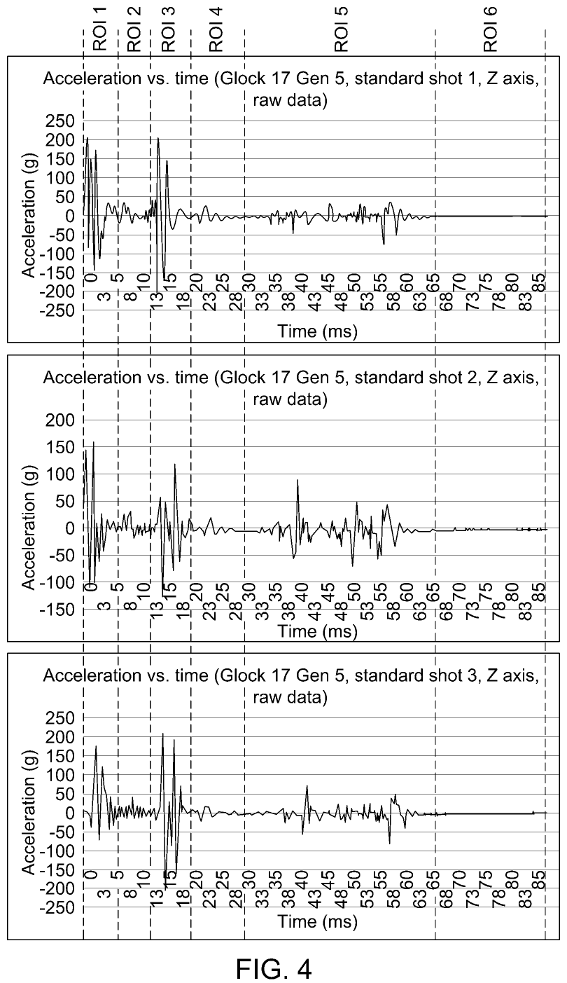

This example identifies regions containing repeatable information about the recoil signature of the Glock 17 Gen 5. Since recoil activity is most prominent on the Z axis in this projectile weapon this is the axis first examined for regions of similar activity. Only a small set of samples is required to identify ROIs. In this example, a sample size of three standard shots is used. Graphs of the Z axis accelerometer activity over 86 ms collected from three standard shots fired are set out in FIG. 4. tfinal was set to 86 ms for the Glock 17 Gen 5 as this weapon cannot realistically be fired twice within this time period. The accelerometer is sampling at 6.4 kHz. Vertical dashed lines are overlaid on the graphs to delineate regions of activity which look similar across all three data sets. Note the X axis time scale is the same for all three graphs—0-86 ms.

The ROIs determined from this Z axis Glock 17 Gen 5 standard shot data are listed in chronological order and explained below. Standard shot is abbreviated herein to SS.

SS ROI 1, 0.00-6.59 ms: period of high acceleration activity with maximum magnitude>150 g.

SS ROI 2, 6.60-13.29 ms: period of less activity with maximum magnitude<100 g.

SS ROI 3, 13.30-19.89 ms: period of high acceleration activity with maximum magnitude>100 g.

SS ROI 4, 19.90-29.89 ms: period of low activity with maximum magnitude<50 g.

SS ROI 5, 29.90-66.39 ms: extended period of continuous moderate activity with maximum magnitude in the range 50-100 g appears from approximately 20-38 ms.

SS ROI 6, 66.40-86.00 ms: stable period of zero activity.

Checking ROI Compatibility with Last Shots

The next step is to compare selected ROI lines with data for Z axis acceleration activity on last shots from the same weapon platform to identify points of difference between standard shots and last shots.

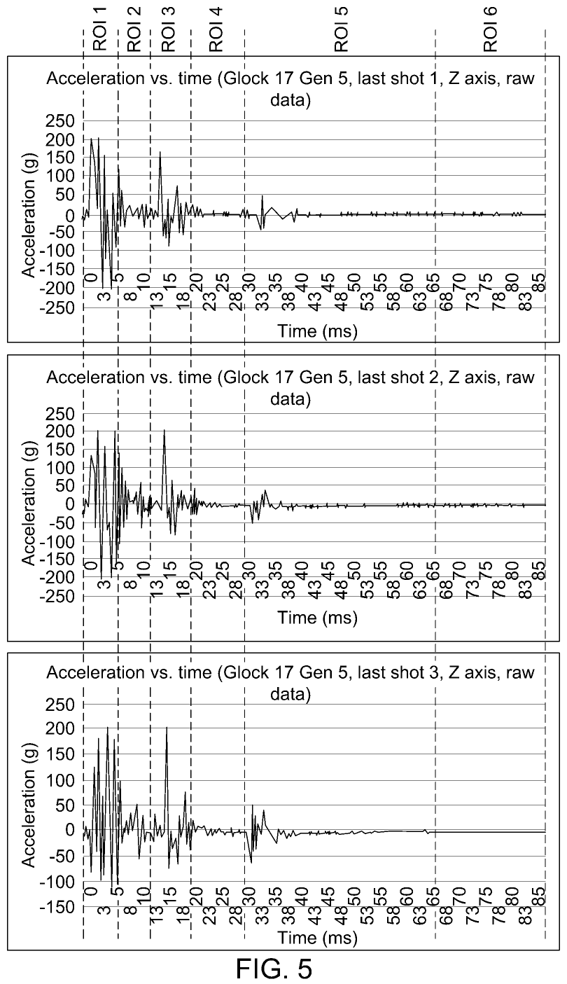

FIG. 5 is a set of graphs depicting shot data for three last shots fired with a Glock 17 Gen 5 using the system depicted in FIG. 1 and FIG. 2. Vertical dashed lines are overlaid to delineate the initial ROIs.

The ROIs determined from standard shots are overlaid onto last shots to determine their compatibility with the differing recoil signature present in last shots from the same fixed weapon platform. SS ROIs are set out below along with their identifying features. On the line following each SS ROI, the features present in each SS ROI are compared for compatibility with the features found in the corresponding last shot ROI. Last shots are henceforth abbreviated as LS.

SS ROI 1, 0.00-6.59 ms: period of high acceleration activity with maximum magnitude>150 g.

LS ROI 1, 0.00-6.59 ms: same identifying features present. SS ROI1 features are compatible with last shots.

SS ROI 2, 6.60-13.29 ms: period of less activity with maximum magnitude<100 g.

LS ROI 2, 6.60-13.29 ms: same identifying features present. SS ROI2 features are compatible with last shots.

SS ROI 3, 13.30-19.89 ms: period of high acceleration activity with maximum magnitude>100 g.

LS ROI 3, 13.30-19.89 ms: same identifying features present. SS ROI3 features are compatible with last shots.

SS ROI 4, 19.90-29.89 ms: period of low activity with maximum magnitude<50 g.

LS ROI 4, 19.90-29.89 ms: same identifying features present. SS ROI4 features are compatible with last shots.

SS ROI 5, 29.90-66.39 ms: extended period of continuous moderate activity with maximum magnitude 50-100 g appears from approximately 33-63 ms.

LS ROI 5, 29.90-66.39 ms: extended period of continuous moderate activity from approximately 33-63 ms not present in last shots. SS ROI 5 features are considerably different in last shots.

SS ROI 6, 66.40-86.00 ms: stable period of zero activity.

LS ROI 6, 66.40-86.00 ms: same identifying features present. SS ROI 6 features are compatible with last shots.

SS/LS ROI Compatibility Summary

As can be seen from the above data and FIGS. 4 and 5, SS ROIs 1, 2, 3, 4 and 6 were found to be compatible with last shots, as the identifying features present on standard shots were also present in the corresponding last shot data.

ROI 5 Standard Shot (SS) data was not consistent with Last Shot (LS) data. As depicted in FIG. 4, ROI 5 SS data contains an extended period of continuous moderate activity from approximately 33-63 ms. In the corresponding ROI in LS data, the moderate activity is only present from 31-41 ms, followed by an extended period of almost zero activity from 41-66 ms. Also, in ROI 5 LS data the maximum magnitude of the activity was a little lower at 25-75 g, as compared to the 50-100 g maximum magnitudes observed in SS ROI 5 data.

The reason for this difference in data is that in the Glock 17 Gen 5, 30 ms after a shot is fired the recoil spring begins accelerating the slide towards the front of the weapon. In a standard shot, the slide is forced all the way to the front of the weapon, pushing the next round in on its way. After a last shot, the slide lock spring pushes the slide lock up which catches the slide near the back of the weapon. In this scenario, significant potential energy is stored in the slide recoil spring which explains why there is significantly less acceleration activity present in this time period on the last shot graphs.

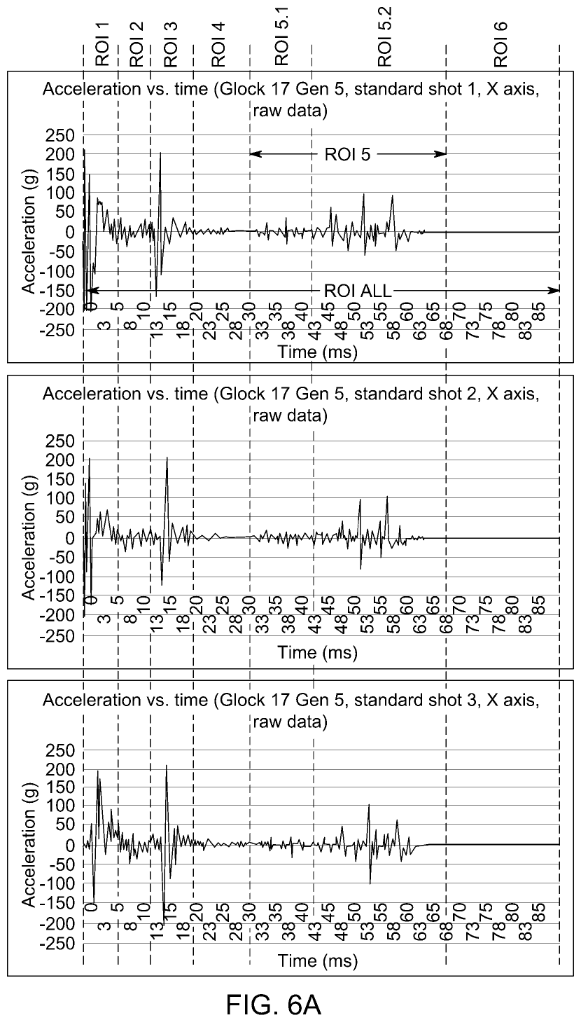

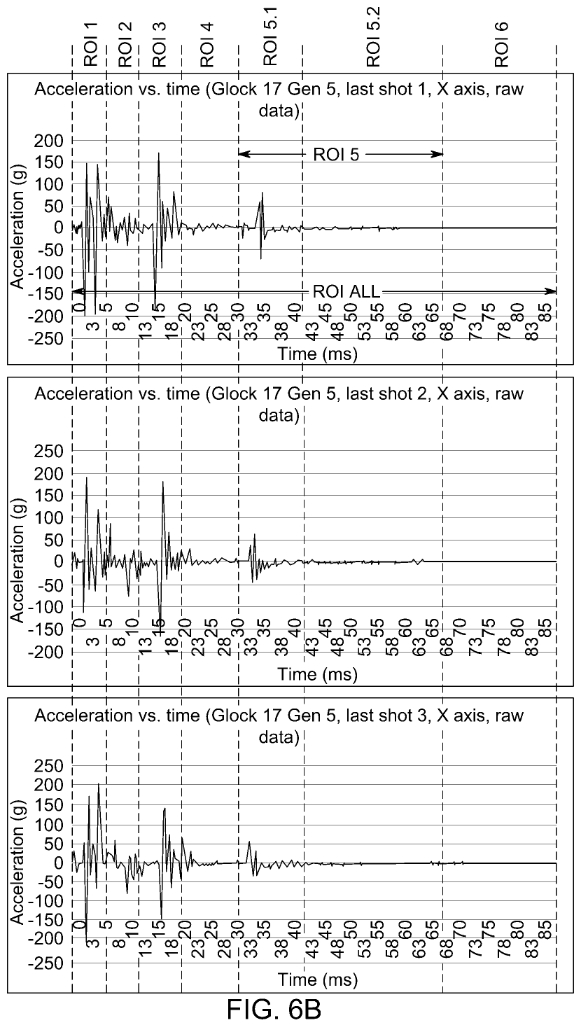

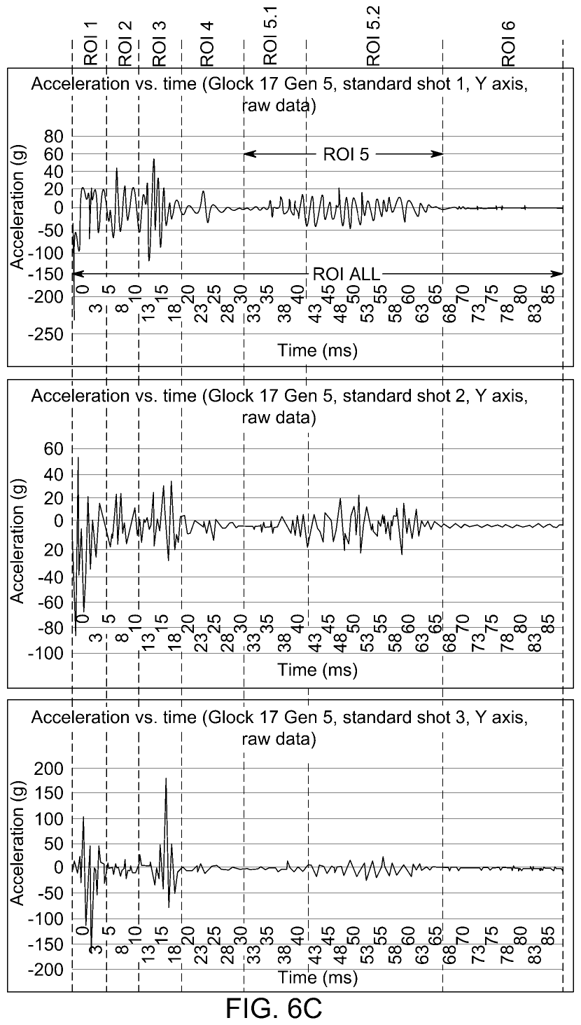

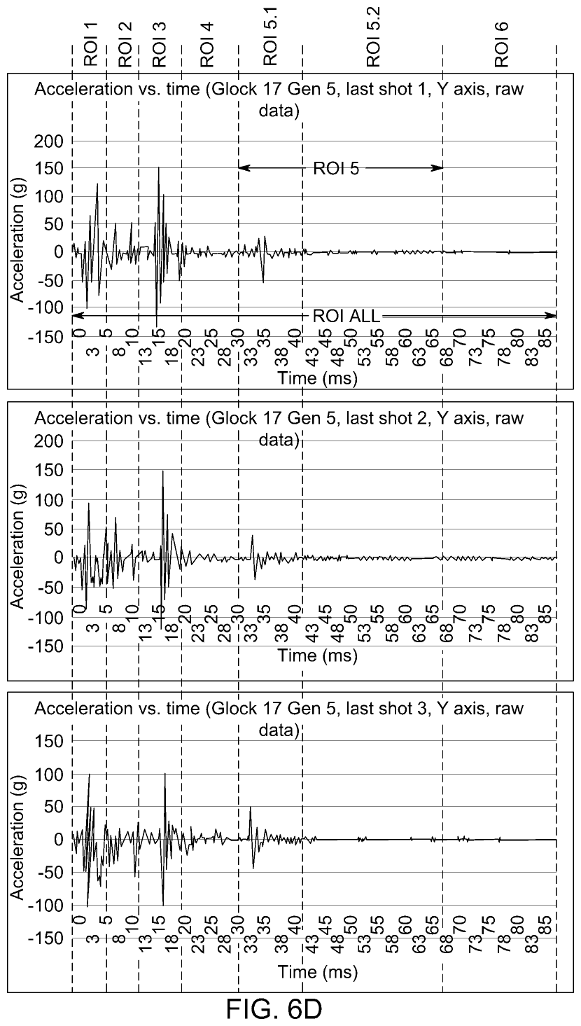

In light of the above, as depicted in FIGS. 6a-6d, two further ROIs are added within ROI 5 to capture the two distinct periods of activity present in last shots in the 29.90-66.39 ms time period. To cater for last shot identification, this time period is split up into two sub regions of ROI 5.1 (29.90-41.49 ms) and ROI 5.2 (41.49-66.39 ms). ROI 5.1 will capture the period of moderate activity on last shots, while ROI 5.2 will capture the period of almost zero activity which follows on that type of shot event.

Determined Final ROIs

ROI 1: 0.00-6.59 ms

ROI 2: 6.60-13.29 ms

ROI 3: 13.30-19.89 ms

ROI 4: 19.90-29.89 ms

ROI 5: 29.90-66.39 ms

ROI 5.1: 29.90-41.49 ms

ROI 5.2: 41.49-66.39 ms

ROI 6: 66.40-86.00 ms

ROI ALL: 0.00-86.00 ms

ROI ALL, consisting of the entire 86 ms collection of data, is added as this provides a way of doing a final check that all properties over the entire sampling duration are within a sensible range before confirming a shot. ROI ALL is also useful for conducting the ratio tests of total activity between axes.

Including ROI 5, 5.1 and 5.2 as one ROI (as ROI 5 comprises ROI 5.1 and 5.2) and including ROI ALL, there are now seven ROIs that can be analysed to assess properties to decide whether a shot or non-shot event has woken the microcontroller (via interrupt from the accelerometer).

FIGS. 6a to 6d are sets of graphs of the X and Y axis data from the three standard shots and three last shots for which Z axis data is depicted in FIGS. 4 and 5 respectively. Vertical dashed lines are overlaid to delineate these final ROIs. This is done to check consistency of activity on the other (non-Z) axes to inform which test types are suitable for each ROI and accelerometer axis combination.

It is evident from FIG. 5 and FIGS. 6a to 6d that the ROIs assigned for the SS and LS data on the Z axis are equally suitable on the X and Y axes. The waveforms are similar on all three axes. Also noteworthy is that the magnitude of the acceleration activity Y axis data (left/right axis) is considerably lower than the X and Z axes as expected.

Test Types to be Implemented

As all axes show repeatable activity in all ROIs, minimum and maximum acceptance gate bound threshold tests can be implemented for each property of each ROI on each axis. This means that for each of the seven ROIs, shot confirmation acceptance gate bounds can be implemented for all seven test types:

Total activity (X);

Total activity (Y);

Total activity (Z);

Total activity (X+Y+Z);

Ratio of Y:Z;

Ratio of Y:X; and

Ratio of Y:SUM.

In this example, for the ratio tests to is set to t0 and tb set to tfinal such that the ratios of total activity on applicable axes are compared over the entire sampling duration of 86 ms.

Zero Drift Correction

Before determining acceptance gate bounds, zero drift correction is applied to the raw data. Because acceptance gate bounds will be applied to calibrated data in actual shot detection, the data determining the acceptance gate bounds should be calibrated before the bounds are set.

The zero drift offset value can be determined by taking the average value on each axis for the period of zero activity. In this example the period of zero activity is ROI 6 (66.40-86.00 ms). Zero drift offset is calculated based on data from the last verified shot recorded on any given physical circuit board. Since all six verified shots shown in the graphs above were collected from the same circuit board, data from the last of those shots to take place—last shot 3—will be used to calculate the zero drift value to apply to all six data sets.

The average value of data entries in ROI 6 for the three axes of the event last shot 3 are listed below.

Last shot 3, X axis average value (ROI 6)=1.089 g

Last shot 3, Y axis average value (ROI 6)=0.612 g

Last shot 3, Z axis average value (ROI 6)=3.255 g

These values are also the current zero drift values for each axis. To calibrate the existing sets of X axis data, the X axis zero drift value of 1.089 g is subtracted from every X axis raw data point such that the calibrated data points are each generated from the equation
X axis calibrated data point=X axis raw data point−X axis zero drift value

Y and Z axis calibrated data sets are created the same way.

Standard Total Activity Acceptance Gate Bounds

Before total activity acceptance gate bounds can be generated, the data set needs to be rectified to convert all negative values into positive values. This is done because the total activity metric is based on integrating the magnitude of activity in each ROI and is not concerned with the sign (direction) of the activity, just the total amount of activity on each axis.

Accordingly, a rectified and calibrated set of X axis data points is generated using the pseudo code below

```
if (X_axis_calibrated_data_point < 0) {
  X_axis_rectified_calibrated_data_point = −
  (X_axis_calibrated_data_point)
}
else {
  X_axis_rectified_calibrated_data_point =
  X_axis_calibrated_data_point
}
```

Y and Z axis rectified calibrated data sets are created using the same process.

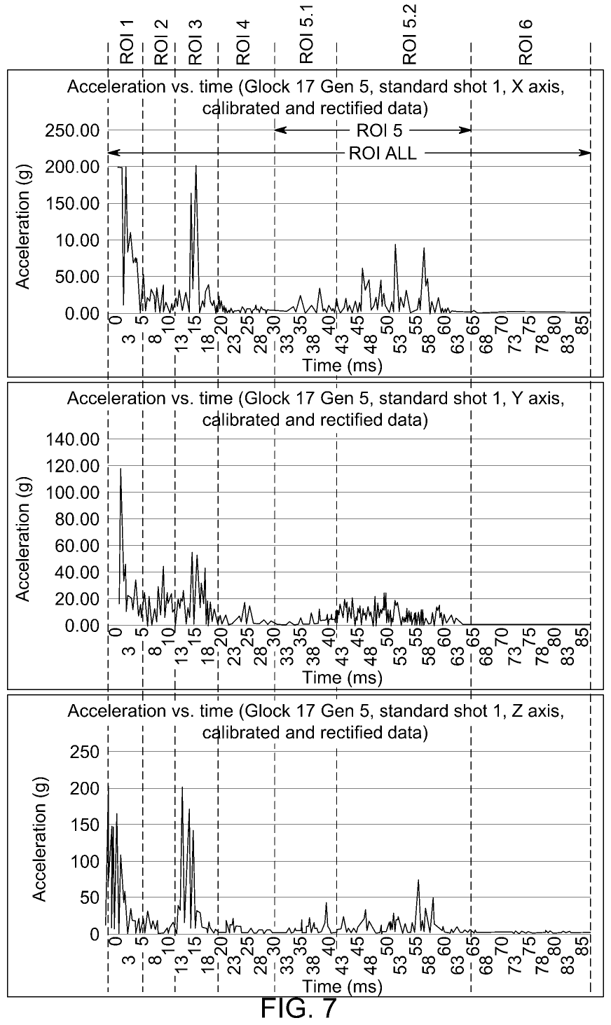

FIG. 7 depicts X, Y and Z axis data from standard shot 1 after calibration and rectification. Dotted lines demarking the previously determined ROIs are overlaid as points of reference. It can be seen that each ROI confirms that the identifying activity is still present in each region, however, as there are now only magnitudes of acceleration, there are no negative values present.

The next step in determining total activity acceptance gate bounds is to acquire the all-time minimum and maximum total activity values for each axis on each ROI which has not been split up to accommodate last shot behaviour. ROIs affected by last shot behaviour in self-loading weapons (in this example ROIs 5, 5.1 and 5.2) need special consideration for the total activity assessment and are considered in the next section.

In this example there is a database of six verified shots to investigate. For a given axis, the total activity metric for a given ROI is calculated by summing all calibrated and rectified values within said ROI in said axis data for the first verified shot. This process is repeated for every verified shot in the database, resulting in a series of values which can then be compared to find the minimum and maximum values recorded.

This process was conducted on Z axis data for the six recorded verified shots to create the table of values below.

Verified shots, Z axis total activity values

| Shot type | ROI 1 |
|---|---|
| SS 1 | 1201.86 |
| SS 2 | 1015.24 |
| SS 3 | 830.78 |
| LS 1 | 1587.88 |
| LS 2 | 1407.23 |
| LS 3 | 1104.15 |

It can be seen that the minimum recorded value is 830.78 and the maximum 1587.88. With a larger database, of say 10,000 verified shots, a processor can loop through an array of values to identify the minimum and maximum values as shown in the pseudo code below.

```
uint32 total_activity_min_Z_axis_ROI1 = array[0];
uint32 total_activity_max_Z_axis_ROI1 = array[0];
uint16 i = 1;
for (i = 1; i = array_length; i++) {
  if (i < total_activity_min_Z_axis_ROI1) {
    total_activity_min_Z_axis_ROI1 = i;
  }
  if (i > total_activity_max_Z_axis_ROI1) {
    total_activity_max_Z_axis_ROI1 = i;
  }
}
```

This process is repeated for each ROI on the Z axis.

This process is then repeated for the X and Y axes.

The above process is then repeated for the value total activity (X+Y+Z). This value is found for every ROI in each verified shot by simply summing the corresponding total activity values from the X, Y and Z axes.

In this example, with only six verified shots in the database, large buffers are applied to these minimum and maximum recorded values in order to arrive at the acceptance gate bounds for the total activity suite of shot confirmation tests. In this example the lower acceptance gate bound is set to minimum_recorded_value×0.5 and the upper acceptance gate bound to maximum_recorded_value×1.5. For ROI 1 on the Z axis, this results in lower and upper acceptance gate bounds of 415.39 and 2381.82 respectively.

Lower and upper acceptance gate bounds for the remaining Z axis ROIs are calculated in an identical fashion.

Lower and upper acceptance gate bounds for each ROI in the X and Y axes and the total activity (X+Y+Z) metric are calculated following the same method.

Special Case Total Activity Acceptance Date Bounds

ROIs affected by the special case of the last shot in self-loading weapons may need extra analysis. In this example this applies to ROI 5, which also comprises ROI 5.1 and 5.2. Rather than having an acceptance gate with one set of upper and lower bounds for each axis or metric, such an ROI may possess an acceptance gate with more than one set of upper and lower bounds for each axis or metric—one set of bounds for passing standard shots and the other for passing last shots. How the acceptance bounds and gates are set in this example is outlined below.

Verified standard shots, Z axis total activity values

| Shot type | ROI 5 | ROI 5.1 | ROI 5.2 |
|---|---|---|---|
| SS 1 | 1247.29 | 317.64 | 929.65 |
| SS 2 | 1644.85 | 489.99 | 1154.86 |
| SS 3 | 1356.23 | 230.19 | 1126.04 |

Verified last shots, Z axis total activity values

| Shot type | ROI 5 | ROI 5.1 | ROI 5.2 |
|---|---|---|---|
| LS 1 | 536.01 | 439.57 | 96.44 |
| LS 2 | 405.37 | 488.04 | 82.67 |
| LS 3 | 594.55 | 511.48 | 83.07 |

The tables above show a large discrepancy in ROI 5 Z axis total activity values between standard shots and last shots. For this metric the overall average is 964.05, however the standard shot average value is 1416.12 while the last shot average value is far lower at 511.98. This confirms that there is a significant difference in acceleration activity in ROI 5 depending on whether a standard shot or a last shot has been fired.

When the usefulness of a ROI data set is in doubt, the sample standard deviation may be used to check whether acceptance gate bounds should be created from the data set or not. If the value of:

Overall Average−3×Sample Standard Deviation

is negative this is a strong indicator that the data is too inconsistent to inform meaningful acceptance gate bounds.

It has been found that for useful ROIs, once a large number of samples is collected, the “total activity” values calculated follow an approximately normal distribution. For a normal distribution 99.73% of values will lie within 3 standard deviations of the overall average (mean). These three standard deviations can be applied to past data sets collected in an attempt to predict the bounds of what future data will look like.

Given that total activity must always be equal to or above zero (because data has been rectified), getting a negative value from the equation “overall average−3× sample standard deviation” shows that the data set for the ROI in question does not follow a normal distribution and has a large degree of variance/randomness to it. The more predictable the total activity of an ROI is, the more useful that ROI is in shot detection.

Calculating the sample standard deviation of this ROI 5, Z axis data set finds a value of sample standard deviation (1247.29, 1644.85, 1356.23, 536.01, 405.37, 594.55)=515.63.

Checking the value of overall average−3× sample standard deviation for suitability yields a result of

overall average−3× sample standard deviation=−582.84

which is more than one full sample standard deviation below zero. Hence ROI 5 is unsuitable for creation of an acceptance gate that will pass both standard shots and last shots.

ROI 5 can still be used. However it is only suitable to generate acceptance gate bounds for passing standard shots. ROIs 5.1 and 5.2 can be used in conjunction to generate separate sets of bounds for passing last shots.

When catering for an ROI such as this which has to pass considerably different acceleration activity depending on whether a standard or last shot has been fired, an OR logic test can be utilised, for example

IF all ROI standard shot acceptance gate tests pass OR all ROI last shot acceptance gate tests pass

THEN ROI acceleration activity is consistent with a valid shot type, hence proceed to the next ROI to continue testing

In this example, ROI 5 is used to create acceptance gate bounds to pass standard shots using the same method as used for ROI 1 above

lower acceptance gate bound (ROI 5, SS)=minimum_recorded_value×0.5=623.65

upper acceptance gate bound (ROI 5, SS)=maximum_recorded_value×1.5=2467.28

And ROIs 5.1 and 5.2 are used to create a pair of acceptance gate bounds to pass last shots. A pair of acceptance gate bounds are used because ROIs 5.1 and 5.2 are two areas of very different (but repeatable) acceleration activity and hence testing each sub-region separately adds value to the test.

The acceptance gate bounds for ROIs 5.1 and 5.2 are derived using the same method

lower acceptance gate bound (ROI 5.1, LS)=minimum_recorded_value×0.5=219.79

upper acceptance gate bound (ROI 5.1, LS)=maximum_recorded_value×1.5=767.22

lower acceptance gate bound (ROI 5.2, LS)=minimum_recorded_value×0.5=41.34

upper acceptance gate bound (ROI 5.2, LS)=maximum_recorded_value×1.5=144.66

If it is desirable to log whether a shot was a standard shot or a last shot, a flag can be set for any acceleration activity which passed through the last shot gates. Checking the standard shot ROI 5.2 values (929.65, 1154.86, 1126.04) and comparing them to the ROI 5.2 acceptance gate bounds (41.34-144.66) makes it clear that a standard shot will not pass through this ROI 5.2 last shot gate. Hence if a shot was confirmed, and the ‘ROI 5.2 LS gate passed’ flag was set, the shot detection system could include metadata in the log of recorded shots showing that this particular shot was a last shot.

Therefore, in some embodiments of the invention, the system and method is configurable to enable a user to be notified of a last shot event. In one example implementation, whenever a shot is verified with the ‘ROI 5.2 LS gate passed’ flag set, the BLE capability on the Device can be used to wirelessly connect to the user's radio or headset and sound a tone to alert them to the fact they had just fired the last shot in their magazine. It will be appreciated that many other suitable methods of alert may be used, depending on the application at hand.

Ratio Test Acceptance Gate Bounds

In this example, ratio tests are applied only to ROI ALL. Before setting acceptance gate bounds for ratio tests, the total activity will be calculated for each axis and for the sum of all axes. The property SUM (X+Y+Z) is calculated by summing the corresponding values from the X, Y and Z axes.

Verified shots, ROI ALL total activity values

| Shot type | X axis | Y axis | Z axis | SUM (X + Y + Z) |
|---|---|---|---|---|
| SS 1 | 4669.66 | 2229.41 | 4435.56 | 11334.63 |
| SS 2 | 4104.25 | 1878.85 | 4412.90 | 10396.00 |
| SS 3 | 4365.41 | 2309.82 | 4279.82 | 10955.05 |
| LS 1 | 3775.87 | 2599.41 | 4717.05 | 11092.33 |
| LS 2 | 3223.55 | 2441.23 | 5194.72 | 10859.50 |
| LS 3 | 3475.62 | 2354.67 | 4418.95 | 10249.24 |

The axis ratios can now be calculated. The total activity axis ratio value Y:Z is found with the following equation

total activity axis ratio value Y:Z=(total activity Y axis)/(total activity Z axis)

and the other ratios are similarly calculated to arrive at the figures in the table below.

ROI ALL total activity axis ratio values

| Shot type | Y:Z | Y:X | Y:SUM |
|---|---|---|---|
| SS 1 | 0.502622 | 0.477424 | 0.196690 |
| SS 2 | 0.425763 | 0.457782 | 0.180728 |
| SS 3 | 0.539700 | 0.529119 | 0.210845 |
| LS 1 | 0.551067 | 0.688427 | 0.234343 |
| LS 2 | 0.469944 | 0.757311 | 0.224801 |
| LS 3 | 0.532857 | 0.677482 | 0.229741 |

Looking at the table shows good consistency within the values of each ratio tested. With the same small sample size, the same method as above may be used to set acceptance gate test bounds—50% of the minimum recorded value for the lower bound and 150% of the maximum recorded value for the upper bound.

Accordingly, the following ratio test bounds are generated

lower acceptance gate bound (ROI ALL, Y:Z)=minimum_recorded_value×0.5=0.425763

upper acceptance gate bound (ROI ALL Y:Z)=maximum_recorded_value×1.5=0.551067

lower acceptance gate bound (ROI ALL, Y:X)=minimum_recorded_value×0.5=0.457782

upper acceptance gate bound (ROI ALL, Y:X)=maximum_recorded_value×1.5=0.757311

lower acceptance gate bound (ROI ALL, Y:SUM)=minimum_recorded_value×0.5=0.180728

upper acceptance gate bound (ROI ALL Y:SUM)=maximum_recorded_value×1.5=0.234343

Implementing the Shot Confirmation Algorithm

The process flow of an example shot confirmation algorithm using the zero drift offset values and acceptance test gates derived above is set out below.

Microcontroller (MCU) is woken on interrupt from accelerometer when a significant acceleration event has occurred.

MCU reads in X, Y and Z axis data from the accelerometer as it becomes available.

MCU subtracts 1.089 from each X axis value, takes the absolute value of the calibrated value then stores in an array of calibrated rectified X values.

MCU subtracts 0.612 from each Y axis value, takes the absolute value of the calibrated value then stores in an array of calibrated rectified Y values.

MCU subtracts 3.255 from each Z axis value, takes the absolute value of the calibrated value then stores in an array of calibrated rectified Z values.

MCU waits for 6.59 ms to elapse so it can commence ROI 1 total activity Z axis acceptance gate testing.

At t6.59 ms, MCU tests new event data against the one implemented acceptance gate for ROI 1 by checking if the new event data total activity ROI 1, Z axis, total activity is greater than 415.39 and less than 2381.82. If the value falls between these bounds, the MCU proceeds to the next step. If the value falls outside these acceptance gate bounds, the MCU deems the new event a non-shot event, instructs the accelerometer to go to sleep and puts itself back to sleep.

If proceeding to the next step, MCU continues reading new data in and waits for 66.39 ms to elapse so it can commence testing new event data against the one implemented acceptance gate for ROI 5 (including sub-regions 5.1 and 5.2).

At t66.39 ms, MCU tests new event data for ROI 5 by checking if EITHER of the following logic statements is true

new event data total activity ROI 5, Z axis>623.65 AND new event data total activity ROI 5, Z axis<2467.28

OR

new event value total activity ROI 5.1, Z axis>219.79 AND new event value total activity ROI 5.1, Z axis<767.22 AND new event value total activity ROI 5.2, Z axis>41.34 AND new event value total activity ROI 5.2, Z axis<144.66

If the first of the above logic statements is true, the MCU proceeds to the next step. If the second of the above logic statements is true, the MCU sets a “last shot” flag and proceeds to the next step. If both of the above logic statements are false, the MCU deems the new event a non-shot event, instructs the accelerometer to go to sleep and puts itself back to sleep.

MCU continues reading new data in and waits for 86.00 ms to elapse so it can commence testing new event data against the three implemented ratio test acceptance gates for ROI ALL.

At t86.00 ms, MCU manipulates new event data to calculate the total activity ratios ROI ALL, Y:Z, ROI ALL, Y:X and ROI ALL, Y:SUM.

MCU tests new event total activity ratios as follows

IF new event total activity ratio ROI ALL, Y:Z>0.425763 AND new event total activity ratio ROI ALL, Y:Z<0.551067 THEN proceed to next step ELSE new event is a non-shot event, put accelerometer to sleep and go back to sleep.

IF new event total activity ratio ROI ALL, Y:X>0.457782 AND new event total activity ratio ROI ALL, Y:X<0.757311 THEN proceed to next step ELSE new event is a non-shot event, put accelerometer to sleep and go back to sleep.

IF new event total activity ratio ROI ALL, Y:SUM>0.180728 AND new event total activity ratio ROI ALL, Y:SUM<0.234343 THEN the new event is confirmed to be a shot ELSE new event is a non-shot event, put accelerometer to sleep and go back to sleep.

MCU receives current timestamp from RTC.

MCU subtracts tfinal from RTC timestamp then writes the new event as shot confirmed to the non-volatile memory with the corrected t0 timestamp added. If the “last shot” flag is set, metadata is added to the non-volatile memory entry declaring the confirmed shot event was also a last shot event.

MCU calculates average X, Y and Z axis values from ROI 6 and updates the zero drift offset value for the X, Y and Z axes with the corresponding average value calculated.

MCU instructs the accelerometer to wake if the predetermined acceleration wake up threshold is exceeded then puts it to sleep.

MCU puts itself to sleep.

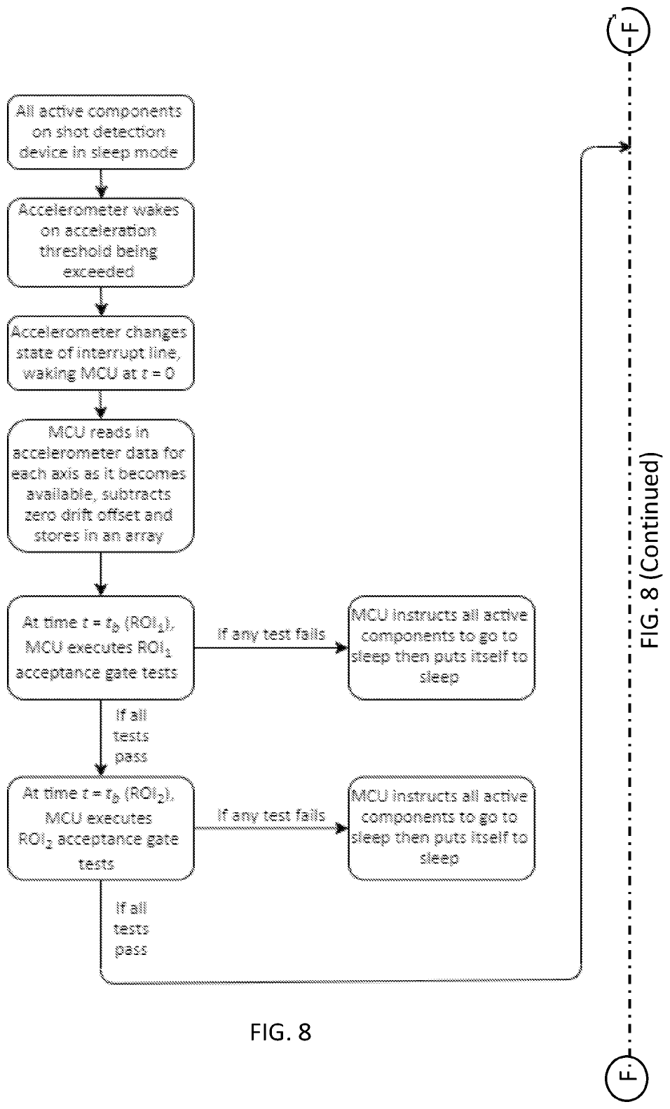

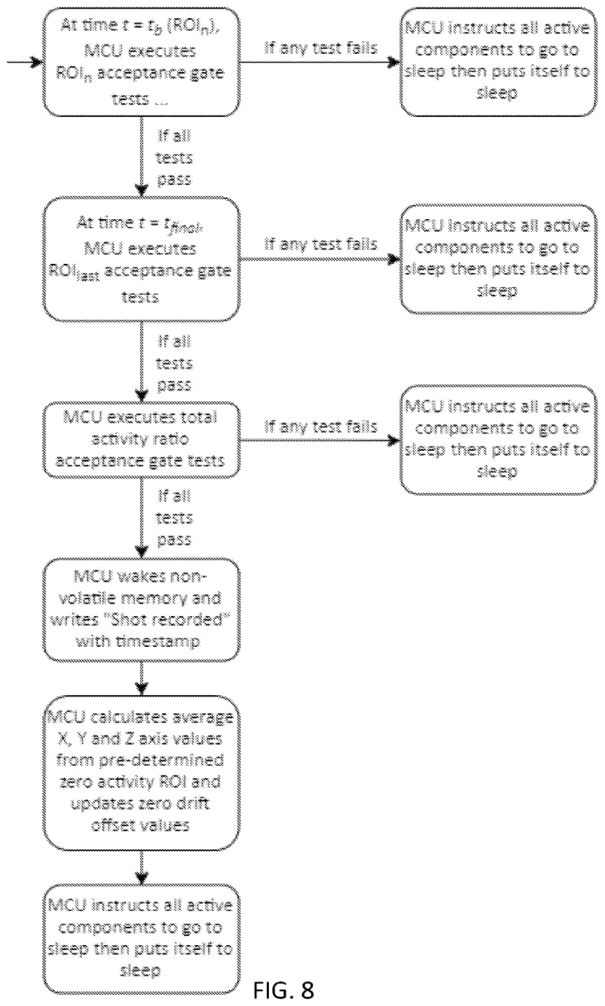

FIG. 8 depicts an example process flow for shot detection according to one aspect of the invention.

The shot detection device's default state is to have all active components in a low-power sleep state. When a shot occurs, in reaction to the projectile being propelled out of the projectile weapon, the weapon experiences a significant acceleration event. The accelerometer on the shot detection device circuit board also experiences a significant acceleration event as its movement is coupled to that of the projectile weapon via the rigid physical mounting.

The accelerometer wakes up because the significant acceleration event is higher than its pre-programmed acceleration wake up threshold on at least one axis. The accelerometer changes the state of the interrupt line monitored by the MCU.

The MCU wakes as, before putting itself to sleep, it programmed itself to wake on a state change of the interrupt line connecting it to the accelerometer. The MCU knows that a significant acceleration event has occurred when woken by a state change on this interrupt line.

The MCU instructs the accelerometer to provide real-time data of the acceleration being experienced by the shot detection device. The MCU reads in acceleration data for the X, Y and Z axis as it becomes available from the accelerometer. As each data point is read in, the MCU subtracts the zero drift offset from the data point before storing it in an array of calibrated data.

The MCU monitors elapsed time while reading in and storing the acceleration data.

When time tb of ROI1 has passed, the MCU calculates any ROI1 properties to be tested. As set out above, example properties which can be tested include one or more of X axis total activity, Y axis total activity, Z axis total activity, SUM (X+Y+Z) of total activity of all axes, ratio of total activities Y:Z; ratio of total activities Y:X and ratio of total activities Y:SUM.

The first ROI 1 property to be tested is compared to acceptance gate bounds, which have been determined based on historical data of characteristics of the recoil signature of a verified shot for this fixed hardware platform. To pass the acceptance gate, the value of the ROI1 property of the current acceleration event must be greater than a lower bound of the acceptance gate test for the corresponding ROI1 property but lower than the corresponding higher bound of that acceptance gate. That is to say that the value of the ROI1 property from the current acceleration event must be within the threshold gate based on historical data. If the acceptance gate test is failed, the MCU deems the acceleration event to be a non-shot event. Since there is no point processing further data on a non-shot event, the MCU then instructs the accelerometer to go to sleep then puts itself back to sleep.

If the acceptance gate test for the first ROI1 property is passed, the MCU then tests the second ROI1 property to be tested against acceptance gate bounds in the same manner as the first ROI1 property was tested. If this second ROI1 property acceptance gate test is failed, the MCU deems the acceleration event to be a non-shot event and puts the accelerometer than itself back to sleep.

The MCU repeats this process until either:
i) an acceptance gate bounds test is failed and the MCU puts the device back into sleep mode; or
ii) every ROI1 property to be tested has been compared to and passed through the corresponding ROI property acceptance gate bounds.

If acceptance gate tests for every ROI1 property have been passed, the MCU resumes reading, calibrating and storing data from the accelerometer until total elapsed time reaches time tb of ROI2.

The MCU then executes the same process on ROI2 data as is explained above for ROI1 data.

If still awake due to every tested ROI2 property passing the acceptance gate bounds, the MCU then executes the same process for every remaining ROI (in chronological order of ROI tb times) until either:
i) any one acceptance gate bounds test is failed and the MCU puts the device put back into sleep mode; or
ii) it finishes processing data and acceptance gate tests for ROI final meaning that every property of every ROI has now passed its corresponding acceptance gate tests.

If ii) takes place, the current acceleration event being processed is confirmed to be a shot event.

If a shot event is confirmed, the MCU wakes the connected real-time-clock (RTC), reads the current time and date then puts the RTC back to sleep.

Since the current timestamp is for time tfinal, and the time t0 is when the shot was actually fired, the MCU subtracts tfinal from the timestamp read from the RTC to create a t0 timestamp.

The MCU wakes the connected non-volatile memory chip and writes “shot recorded” along with the t0 timestamp. The MCU puts the non-volatile memory chip back to sleep.

The MCU calculates average X, Y and Z axis values from the pre-determined zero activity ROI.

The MCU updates the zero drift offset value for the X, Y and Z axes with the corresponding average value calculated.

The MCU instructs the accelerometer to wake if the predetermined acceleration wake up threshold is exceeded then puts it to sleep.

The MCU puts itself to sleep.

Recording direction of shot fired

In some embodiments it may be preferable to include the direction the projectile weapon was being pointed in when it was fired along with the timestamped shot recorded tag. In such an embodiment the MCU would need to read the direction from the connected magnetometer or compass every time it woke up to process an event. Unlike the t0 timestamp, which can be calculated retrospectively after a shot is confirmed, the direction the weapon was pointed in must be noted immediately on every wake up. The direction a weapon is pointed in can change considerably in the time it takes for the data of a shot event to be collected, processed and confirmed to be a shot (more than 86 ms for the Glock 17 Gen 5 algorithm example provided in this specification) and there is no way of interrogating the magnetometer to find out which direction is was pointing in at some time in the past. Hence to enable this feature, the above MCU process flow would be modified as shown below.

The MCU wakes on significant acceleration event as detailed above.

The MCU wakes the connected magnetometer or compass, reads the current direction from it and puts it back to sleep.

The MCU stores the current direction in RAM.

* MCU wakes accelerometer and runs shot detection algorithm exactly as described above *

If the event is deemed to be a non-shot event, the MCU discards the current direction stored in RAM and puts the system back to sleep.

If a shot event is confirmed the MCU wakes the RTC and calculates t0 as described above.

The MCU wakes the connected non-volatile memory chip and writes “shot recorded” along with the t0 timestamp and the direction read from the magnetometer or compass when it first woke up. The MCU puts the non-volatile memory chip back to sleep.

The MCU calculates average X, Y and Z axis values from the pre-determined zero activity ROI.

The MCU updates the zero drift offset value for the X, Y and Z axes with the corresponding average value calculated.

The MCU instructs the accelerometer to wake if the predetermined acceleration wake up threshold is exceeded then puts it to sleep.

The MCU puts itself to sleep.

Shot Fired Alerts

If the projectile weapon shot detection system is fitted with communication capabilities (for example wireless), for certain applications (for example law enforcement agencies), when a shot was confirmed an instruction could be transmitted to the law enforcement officer's radio to trigger the duress signal over their network. The shot detection system would have to be pre-configured such that communication between the MCU and the law enforcement officer's radio was enabled to allow this feature.

For direct communication, the MCU would need to have a direct wireless link to the radio established. For the example circuit layout depicted in FIG. 1, this wireless link could be achieved via direct BLE wireless pairing. The MCU process flow for this shot fired alert feature via direct BLE communication is outlined below.

MCU confirms shot event as per the steps in the MCU process flow explained above.

MCU instructs BLE wireless chipset to transmit “activate duress signal” command to a paired law enforcement officer's radio (if present).

For the example circuit layout depicted in FIG. 1, this same shot fired alert functionality could also be achieved indirectly via BLE wireless pairing to a shot detection system wireless dongle, which was physically connected to the law enforcement officer's radio. The shot detection system dongle could wirelessly receive the duress signal command from the shot detection system MCU, then inject the command into the radio via its physical connection. The MCU process flow for this shot fired alert feature via indirect BLE communication is outlined below.

MCU confirms shot event as per the steps in the MCU process flow explained above.

MCU instructs BLE wireless chipset to transmit “activate duress signal” command to a paired shot detection system wireless dongle (if present), which then injects the command into the law enforcement officer's radio via its physical connection.

Use of Pattern Matching Software to Determine ROIs and Create a Detection Algorithm

Identification of ROIs is achieved using pattern matching software in some embodiments. According to one exemplary implementation, the pattern matching software used to auto generate a detection algorithm requires, at a minimum, data from all three axes of the 3-axis accelerometer for at least three shots from the fixed weapon platform it is generating an algorithm for. The pattern matching software can only generate an algorithm for one shot type (i.e. standard or last shot) at a time, and when generating an algorithm, all shot data fed to it must not only be from a fixed weapon platform but also from the same shot type.

Two detection algorithms can be stored on an MCU at the same time. Hence if an algorithm is being generated for a projectile weapon which has a standard shot and a last shot which differ in nature, a stand-alone algorithm for standard shots can be generated, followed by a stand-alone algorithm for last shots. Both algorithms can be loaded on the same MCU and run subsequently when the MCU is woken from an accelerometer interrupt.

The first step is to define a sampling time for the shot data. The sampling time needs to be long enough to capture the full waveform of the shot and ensuing cycling of the weapon (for semi-automatic and automatic weapons), but also needs to be short enough such that the shot detection system has finished processing the previous event before a potential next shot is fired.

In the absence of human input, data sampling time defaults to 100 ms. This time is chosen as default because it's long enough to capture the shot and weapon cycle waveforms of commonly used firearms such as the Glock 17 Gen 5, but also short enough that non-automatic projectile weapons generally cannot be fired twice by a human in this time period.

Many fully automatic weapons such as assault rifles can fire shots faster than this. For a weapon that can be fired faster than this, human input is required to set the sampling time accordingly. Sampling time should be set to 5 ms less than the minimum possible time between shots for the fixed weapon platform the pattern matching software is being used on. This time of 5 ms is appropriate because the microcontroller takes up to 4 ms to process an event to determine if it is a shot or not (it will take longer to process for longer total sampling times). Another up to 1 ms is required if a shot is confirmed in order for the MCU to store the event in non-volatile memory then put peripheral parts and itself back to sleep. Hence 5 ms after a shot event is long enough to ensure the shot detection system has enough time to do all its processing and go back to sleep in preparation for detecting the next potential shot which could be fired.

The maximum sampling time a human can input is set at 150 ms. Total sample time cannot exceed this time because it results in the MCU having to run too many ROI tests to determine whether a shot has been fired or not. Running too many ROI tests can result in the 4 ms maximum allowable event processing time to be exceeded.

Once sampling time is set the next step is to collect data (minimum three shots) for the pattern matching software to analyse.

The pattern matching software can now determine ROIs. It beings with ROI determination for the Z (parallel to the weapon barrel) axis. The software iterates through the Z axis shot data using a sliding window approach to identify ROIs with repeatable acceleration activity on all shots in the database. The width of the first sliding window is 4 ms. 4 ms is selected as the minimum time for a sliding window because the variability of activity between shots is too high for time periods less than 4 ms. The pattern matching software then stores in a 4 ms sliding window array the following datasets
i) the 4 ms window for which there was the most activity per ms, along with the minimum and maximum values of rectified then summed activity within this window
ii) the 4 ms window for which there was the second most activity per ms, which does not overlap at all with the sliding window from i), along with the minimum and maximum values of rectified then summed activity within this window
iii) the 4 ms window for which there was the least activity per ms, along with the minimum and maximum values of rectified then summed activity within this window
The pattern matching software then stores in an array two more datasets
iv) the 4 ms window for which there was the least variation between values of rectified then summed activity, along with the minimum and maximum values of rectified then summed activity within this window
v) the 4 ms window for which there was the second least variation between values of rectified then summed activity, which does not overlap at all with the sliding window from iv), along with the minimum and maximum values of rectified then summed activity within this window

Five datasets, each containing an ROI with a start and an end time along with minimum and maximum values of rectified then summed activity within this ROI, are now stored in the 4 ms sliding window array.

The pattern matching software then repeats the above process with a sliding window time of 6 ms, storing the five new datasets in a newly created 6 ms sliding window array.

The pattern matching software then repeats the above process with a new sliding window time of new sliding window time (in ms)=previous sliding window time (in ms)+2 ms

This process of incrementing sliding window time by 2 ms then repeating steps i) through vii) and storing the five datasets in a new array is repeated until the following condition is met new sliding window time (total sample time minus 1 ms)/3 at which point the iteration of analysing increasingly large sliding windows is halted. The process is halted here because moving to a new sliding window time (total sample time minus 1 ms)/3 may make it impossible to fulfil the non-overlap conditions imposed on datasets ii) and iv).

One more dataset is then generated for ROI ALL, where ROI ALL=total sampling time. Minimum and maximum values on record for rectified then summed activity within this ROI are recorded.

The pattern matching software now has a series of arrays recorded, each containing five datasets comprising an ROI with start and end time along with the minimum and maximum values of rectified then summed activity within this ROI recorded. It also has a single dataset recorded for ROI all.

The pattern matching software then generates total activity acceptance gate bounds for every dataset recorded above. For each ROI, the size of the buffers applied to the maximum recorded value (for the upper acceptance gate bound) and the minimum recorded value (for the lower acceptance gate bound) are determined from the table below.

| Verified shots | ROI lower | |
|---|---|---|
| in database | algorithm bound | ROI upper algorithm bound |
| 3 | Minimum all time | Maximum all time value +50% |
| | value −50% | |
| 10 | Minimum all time | Maximum all time value +40% |
| | value −40% | |
| 100 | Minimum all time | Maximum all time value +30% |
| | value −30% | |
| 1000 | Minimum all time | Maximum all time value +20% |
| | value −20% | |
| 10000 | Minimum all time | Maximum all time value +10% |
| | value −10% | |
| Verified shots | ROI lower | ROI upper algorithm bound |
| in database | algorithm bound | |

The pattern matching software then repeats the entire Z axis data process described above for:

Y axis data;

Z axis data; and

(X+Y+Z) axis data.

By combining all of the above ROI tests, a detection algorithm for the fixed weapon platform being investigated has now been generated.

Data from Glock 19 Gen 15

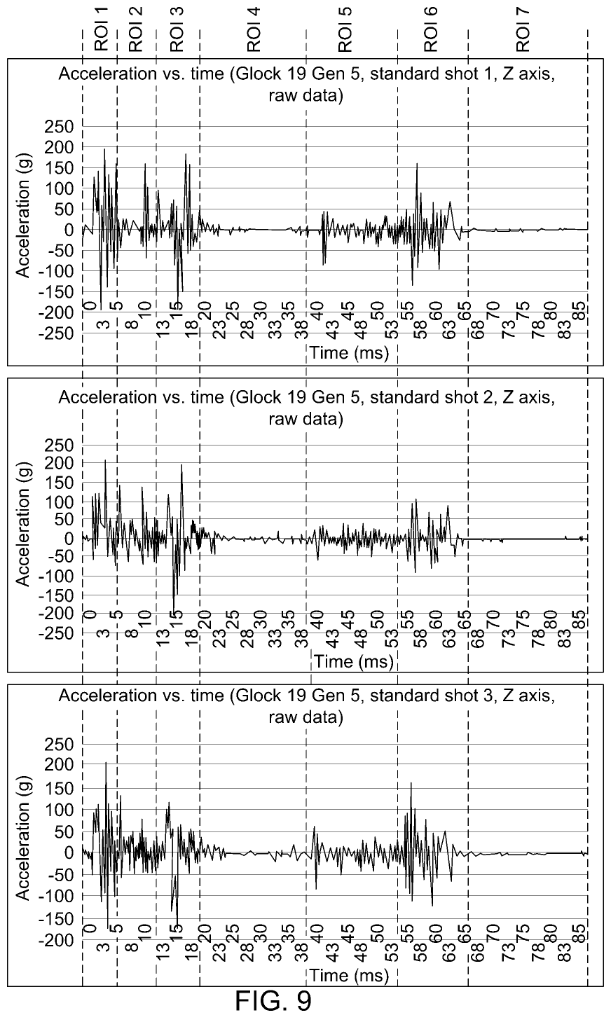

Z axis accelerometer data collected from three standard shots fired from the Glock 19 Gen 5 using the example apparatus depicted in FIGS. 1a and 1b is presented in FIG. 9. This data can be analysed to identify suitable ROIs for shot detection using the same method that was used for the Glock 17 Gen 5 data.

Since recoil activity is most prominent on the Z axis in this projectile weapon this is the axis first examined for regions of similar activity. tfinal was set to 86 ms for the Glock 19 Gen 5 as this weapon cannot realistically be fired twice within this time. The accelerometer is sampling at 6.4 kHz. Vertical dashed lines are overlaid on the graphs to delineate regions of activity which look similar across all three data sets. Note the X axis time scale is the same for all three graphs−0-86 ms.

The ROIs determined from this Z axis Glock 19 Gen 5 SS data are listed in chronological order and explained below.

SS ROI 1, 0.00-6.59 ms: period of extremely high acceleration activity with maximum magnitude>150 g.

SS ROI 2, 6.60-13.29 ms: period of high to extremely high acceleration activity with maximum magnitude between 50 g and 200 g.

SS ROI 3, 13.30-19.89 ms: period of high acceleration activity with maximum magnitude>100 g.

SS ROI 4, 19.90-37.99 ms: period of low acceleration activity with a maximum magnitude<50 g.

SS ROI 5, 38.00-53.99 ms: period of continuous moderate acceleration activity with maximum magnitude in the range 50-100 g.

SS ROI 6, 54.00-66.39 ms: period of high acceleration activity with maximum magnitude in the >100 g.

SS ROI 7, 66.40-86.00 ms: stable period of zero activity suitable for use in zero drift calibration.

Following the same method as previously disclosed, the next step is to compare selected ROI boundaries with graphs showing Z axis acceleration activity on last shots from the same weapon platform to identify points of difference between standard shots and last shots. This

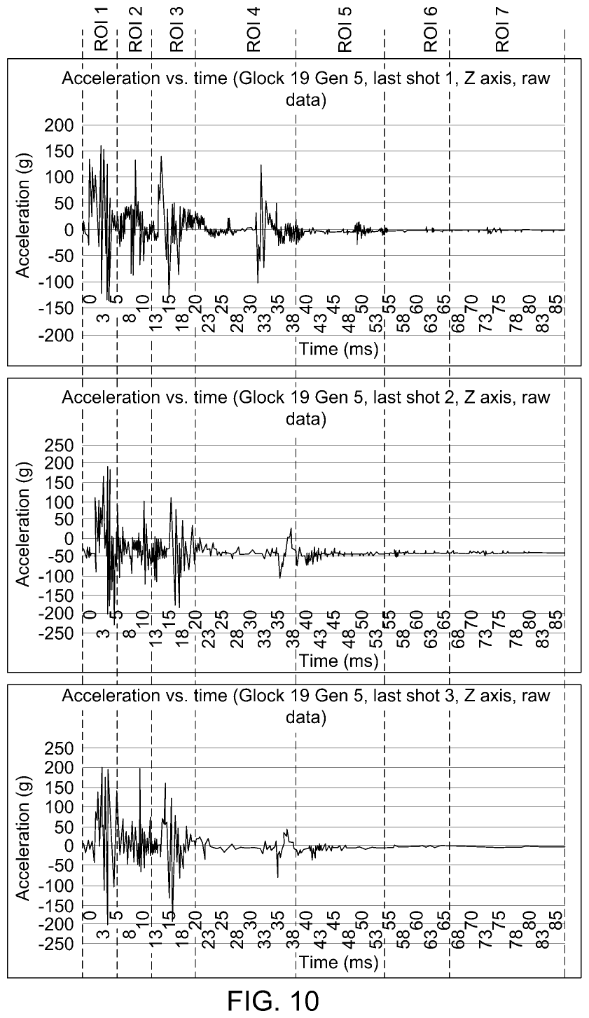

Glock 19 Gen 5 Z axis LS data is presented in FIG. 10. SS ROI analysis is compared with LS ROI analysis below, followed by an assessment of whether the acceleration features present in the SS ROI are compatible with the features present in the corresponding LS ROI.

SS ROI 1, 0.00-6.59 ms: period of extremely high acceleration activity with maximum magnitude>150 g.

LS ROI 1, 0.00-6.59 ms: same identifying features present. SS ROI1 features are compatible with last shots.

SS ROI 2, 6.60-13.29 ms: period of high to extremely high acceleration activity with maximum magnitude between 50 g and 200 g.

LS ROI 2, 6.60-13.29 ms: same identifying features present. SS ROI2 features are compatible with last shots.

SS ROI 3, 13.30-19.89 ms: period of high acceleration activity with maximum magnitude>100 g.

LS ROI 3, 13.30-19.89 ms: same identifying features present. SS ROI3 features are compatible with last shots.

SS ROI 4, 19.90-37.99 ms: period of low acceleration activity with maximum magnitude<50 g.

LS ROI 4, 19.90-37.99 ms: period of moderate acceleration activity with a moderate to high maximum magnitude>50 g. SS ROI 4 features are considerably different in last shots.

SS ROI 5, 38.00-53.99 ms: period of continuous moderate acceleration activity with maximum magnitude in the range 50-100 g.

LS ROI 5, 38.00-53.99 ms: period of low acceleration activity with maximum magnitude<30 g. SS ROI 5 features are considerably different in last shots.

SS ROI 6, 54.00-66.39 ms: period of high acceleration activity with maximum magnitude in the >100 g.

LS ROI 6, 54.00-66.39 ms: stable period of zero activity. SS ROI 6 features are considerably different in last shots.

SS ROI 7, 66.40-86.00 ms: stable period of zero activity suitable for use in zero drift calibration.

LS ROI 7, 66.40-86.00 ms: same identifying features present. SS ROI7 features are compatible with last shots.

The features present in SS ROIs 1, 2, 3 and 7 were found to also be present in the corresponding LS ROIs. ROIs 4, 5 and 6 were found to have considerably different acceleration activity for SS compared to LS.

New ROIs do not necessarily have to be created to cater for the difference between features in ROIs for which the acceleration activity varies between SS and LS. In this example, when considering the Glock 19 Gen 5 Z axis data, a successful shot confirmation algorithm can be implemented without having to create new ROIs (or sub-ROIs) specifically for LS detection. The same ROIs can be used for both SS and LS as long as two sets of acceptance gate bounds are created for ROIs where the activity is considerably different between SS and LS—one set for passing SS and one set for passing LS. Determining the value of the lower and upper bounds for each ROI's acceptance gate can be done using the same method that was utilised for the Glock 17 Gen 5 data earlier in this specification. The implementation of the shot detection algorithm can also be done using the same method previously disclosed.

Data from Glock 45

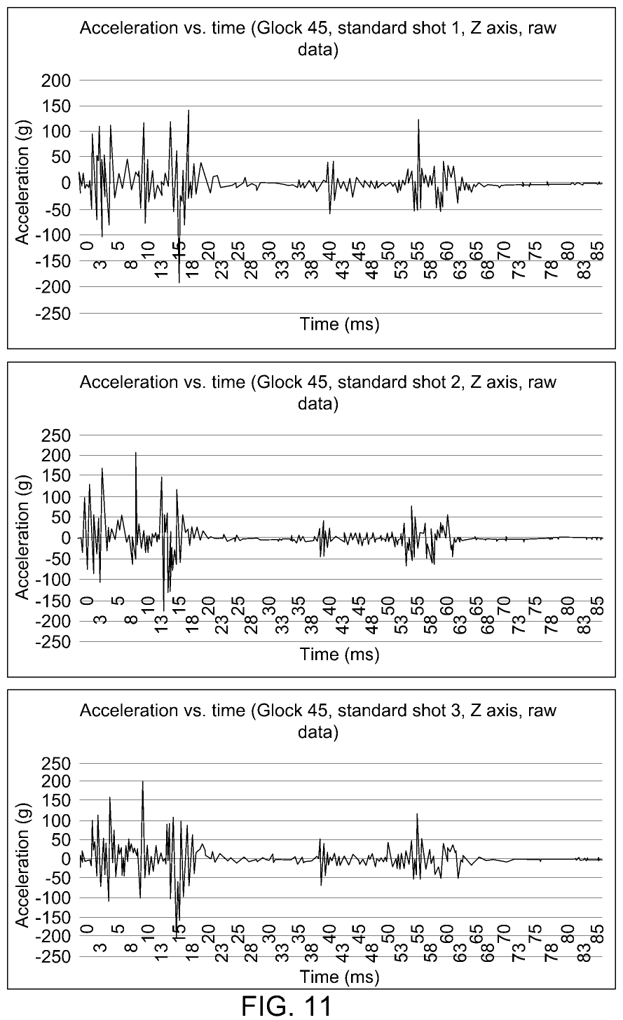

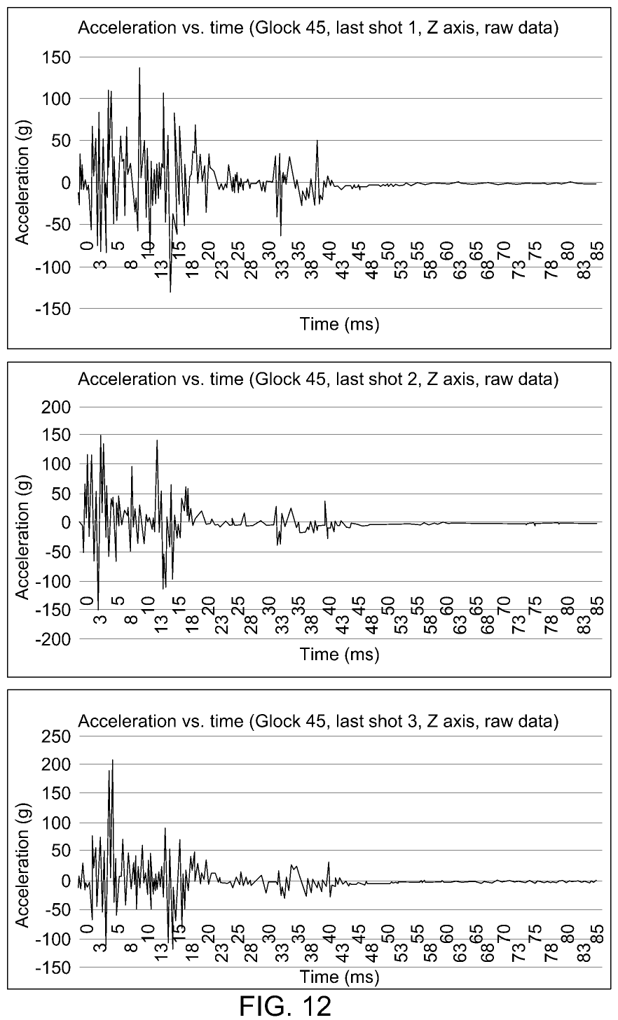

Z axis accelerometer data collected from three standard shots fired from the Glock 45 using the example apparatus depicted in FIGS. 1 and 2 is presented in FIG. 11. Z axis accelerometer data collected from three last shots fired from the Glock 45 using the example apparatus depicted in FIGS. 1 and 2 is presented in FIG. 12. Since key identifying features are common on the accelerometer waveforms for all shots of a given type (SS or LS), the methods disclosed above can be used to create a shot detection algorithm for the Glock 45. It is convenient to describe the invention herein in relation to particularly preferred embodiments. However, the invention is applicable to a wide range of implementations and it is to be appreciated that other constructions and arrangements are also considered as falling within the scope of the invention. Various modifications, alterations, variations and or additions to the construction and arrangements described herein are also considered as falling within the ambit and scope of the present invention. As a specific example of this principle, the system and method of the invention enables accurate shot detection for any projectile weapon which has at least some recoil, provided that the accelerometer is rigidly mounted to the projectile weapon in a fixed location and orientation.

1. A shot detection system for a projectile weapon comprising:
an accelerometer;
a power source;
a memory; and
a processor configured to:
receive accelerometer data from the accelerometer;
for a first region of interest, test a first property of the accelerometer data; and
store a shot determination result in the memory.

2. A system according to claim 1 wherein the processor is configured to test a second property of the first region of interest only if the test of the first property of the first region of interest is passed.

3. A system according to claim 2 wherein the processor is configured to test a third property of the first region of interest only if the test of the second property of the first region of interest is passed.

4. A system according to claim 3 wherein the processor is configured to test a fourth property of the first region of interest only if the test of the third property of the first region of interest is passed.

5. A system according to claim 1 wherein the processor is configured to test a first property of a second region of interest only if all tests of the first region of interest are passed.

6. A system according to claim 5 wherein the processor is configured to test a second property of the second region of interest only if the test of the first property of the second region of interest is passed.

7. A system according to claim 6 wherein the processor is configured to test a third property of the second region of interest only if the test of the second property of the second region of interest is passed.

8. A system according to claim 7 wherein the processor is configured to test a fourth property of the second region of interest only if the test of the third property of the second region of interest is passed.

9. A system according to claim 1 wherein the processor is configured to test a first property of a fourth region of interest only if all tests of all previous regions of interest are passed.

10. A system according to claim 1 wherein the processor is configured to assign pass to shot determination event only if the forces acting on the X axis are greater than those acting on the Y axis.

11. A system according to claim 1 wherein the processor is configured to assign a pass to shot determination event only if the forces acting on the Z axis are greater than those acting on the Y axis.

12. A system according to claim 1 wherein the processor is configured to decrease the size of algorithm acceptance gate bound buffers based on the size of the database of verified shots.

13. A system according to claim 1 wherein the processor is configured to generate a first set of acceptance gate bounds for standard shots and a second set of acceptance gate bounds for last shots.

14. A computer implemented method of shot detection comprising:
receiving accelerometer data from an accelerometer;
for a given region of interest, processing the data to test n properties of the accelerometer data;
determining whether a shot has occurred from at least one test result; and
storing the shot determination in a memory;
wherein n is an integer between 1 and 30.

15. (canceled)

16. (canceled)

17. A method according to claim 14 comprising testing a first property of the second region of interest only if all tests of the first region of interest are passed.

18. A method according to claim 14 comprising testing a second property of the second region of interest only if the test of the first property of the second region of interest is passed.

19. A method according to claim 14 comprising testing a third property of the second region of interest only if the test of the second property of the second region of interest is passed.

20. (canceled)

21. A method according to claim 14 wherein n is an integer between 1 and 10.

22. A method according to claim 14 wherein n is an integer between 2 and 8.

23. A computer implemented method for detecting a shot from a projectile weapon comprising:
receiving acceleration data generated by an accelerometer in fixed engagement with respect to the projectile weapon;
for a first region of interest, testing a first property of the acceleration data;
if the test is passed, testing a second property of the acceleration data;
determining that a non-shot event has occurred on failure of any one of the first region of interest tests;
determining that a shot event has occurred if every one of the first region of interest tests is passed.

24-29. (canceled)
